(19) United States
(12) Patent Application Publication
(10) Pub. No.: US 2024/0292346 A1
(43) Pub. Date: Aug. 29, 2024

(54) POWER CONTROL FOR CHARGING USER EQUIPMENT AND WEARABLES

(71) Applicant: QUALCOMM INCORPORATED, San Diego, CA (US)

(72) Inventors: Ahmed Elshafie, San Diego, CA (US); Sony Akkarakaran, Poway, CA (US); Alexandros Manolakos, Athens (GR); Seyedkianoush Hosseini, San Diego, CA (US)

(21) Appl. No.: 18/569,961

(22) PCT Filed: Aug. 1, 2022
(86) PCT No.: PCT/US2022/074380

§ 371 Date: Dec. 13, 2023

(30) Foreign Application Priority Data
Aug. 13, 2021 (GR) 20210100551

(51) Int. Cl. H04W 52/38; H02J 50/00; H02J 50/20; H04W 52/24; H04W 52/36

(52) U.S. Cl. CPC H04W 52/383; H02J 50/001; H02J 50/20; H04W 52/242; H04W 52/367

(57) ABSTRACT

Methods, systems, and devices for wireless communications are described. A transmitting user equipment (UE) may receive different configurations for determining a first transmit power for data transmissions and a second transmit power for energy harvesting transmissions. The different configurations may include different parameters for determining (e.g., calculating) the first transmit power and the second transmit power. In some aspects, the transmitting UE may also receive an indication of the second transmit power from a receiving UE such that the second transmit power may be determined in accordance with the capabilities of the receiving UE (e.g., based on an energy harvesting circuit at the UE). The indication of the second transmit power may be an indication of one or more parameters used to determine (e.g., calculate) the second transmit power.

### CROSS REFERENCES

The present Application is a 371 national stage filing of International PCT Application No. PCT/US2022/074380 by ELSHAFIE et al. entitled “POWER CONTROL FOR CHARGING USER EQUIPMENT AND WEARABLES,” filed Aug. 1, 2022; and claims priority to Greek patent application Ser. No. 20/210100551 by ELSHAFIE et al. entitled “POWER CONTROL FOR CHARGING USER EQUIPMENT AND WEARABLES,” filed Aug. 13, 2021, each of which is assigned to the assignee hereof, and each of which is expressly incorporated by reference in its entirety herein.

### FIELD OF TECHNOLOGY

The following relates to wireless communications, including power control for charging user equipment and wearables.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may be configured to harvest energy from one or more signals received from another device (e.g., another UE or a base station). Improved techniques for facilitating energy harvesting in a wireless communications system may be desirable.

### SUMMARY

The described techniques relate to improved methods, systems, devices, and apparatuses that support power control for charging user equipment (UE) and wearables. A transmitting UE may receive different configurations for determining a first transmit power for data transmissions and a second transmit power for energy harvesting transmissions. The different configurations may include different parameters for determining (e.g., calculating) the first transmit power and the second transmit power. In some aspects, the transmitting UE may also receive an indication of the second transmit power from a receiving UE such that the second transmit power may be determined in accordance with the capabilities of the receiving UE (e.g., based on an energy harvesting circuit at the receiving UE). The indication of the second transmit power may be an indication of one or more parameters used to determine (e.g., calculate) the second transmit power. The transmitting UE may then transmit the data transmissions using the first transmit power and transmit the energy harvesting transmission using the second transmit power to improve the efficiency of energy harvesting at the receiving UE.

A method for wireless communication at a first UE is described. The method may include receiving a first configuration for setting a first transmit power for one or more data transmissions and a second configuration for setting a second transmit power for one or more energy harvesting transmissions, transmitting, to a second UE, the one or more data transmissions using the first transmit power based on receiving the first configuration, and transmitting, to the second UE, the one or more energy harvesting transmissions using the second transmit power based on receiving the second configuration.

An apparatus for wireless communication at a first UE is described. The apparatus may include a processor, memory coupled with the processor, and instructions stored in the memory. The instructions may be executable by the processor to cause the apparatus to receive a first configuration for setting a first transmit power for one or more data transmissions and a second configuration for setting a second transmit power for one or more energy harvesting transmissions, transmit, to a second UE, the one or more data transmissions using the first transmit power based on receiving the first configuration, and transmit, to the second UE, the one or more energy harvesting transmissions using the second transmit power based on receiving the second configuration.

Another apparatus for wireless communication at a first UE is described. The apparatus may include means for receiving a first configuration for setting a first transmit power for one or more data transmissions and a second configuration for setting a second transmit power for one or more energy harvesting transmissions, means for transmitting, to a second UE, the one or more data transmissions using the first transmit power based on receiving the first configuration, and means for transmitting, to the second UE, the one or more energy harvesting transmissions using the second transmit power based on receiving the second configuration.

A non-transitory computer-readable medium storing code for wireless communication at a first UE is described. The code may include instructions executable by a processor to receive a first configuration for setting a first transmit power for one or more data transmissions and a second configuration for setting a second transmit power for one or more energy harvesting transmissions, transmit, to a second UE, the one or more data transmissions using the first transmit power based on receiving the first configuration, and transmit, to the second UE, the one or more energy harvesting transmissions using the second transmit power based on receiving the second configuration.

Some examples of the method, apparatuses, and non-transitory computer-readable medium described herein may further include operations, features, means, or instructions for receiving, from the second UE, an indication of a value for determining the second transmit power for the one or more energy harvesting transmissions and determining the second transmit power for the one or more energy harvesting transmissions using the indicated value.

Some examples of the method, apparatuses, and non-transitory computer-readable medium described herein may further include operations, features, means, or instructions for receiving, from the second UE, feedback associated with the one or more energy harvesting transmissions and determining an updated transmit power for subsequent energy harvesting transmissions to the second UE based on the received feedback.

In some examples of the method, apparatuses, and non-transitory computer-readable medium described herein, the indicated value may be based on a quality of service level associated with the one or more energy harvesting transmissions.

Some examples of the method, apparatuses, and non-transitory computer-readable medium described herein may further include operations, features, means, or instructions for identifying an alpha value to use to determine the second transmit power based on a fraction of the second transmit power used at the second UE for energy harvesting and determining the second transmit power for the one or more energy harvesting transmissions using the identified alpha value.

In some examples of the method, apparatuses, and non-transitory computer-readable medium described herein, identifying the alpha value may include operations, features, means, or instructions for receiving, from a base station or from the second UE, the alpha value to use to determine the second transmit power, where the alpha value may be based on the fraction of the second transmit power used at the second UE for energy harvesting.

In some examples of the method, apparatuses, and non-transitory computer-readable medium described herein, identifying the alpha value may include operations, features, means, or instructions for identifying the alpha value to use to determine the second transmit power based on a class of the second UE.

Some examples of the method, apparatuses, and non-transitory computer-readable medium described herein may further include operations, features, means, or instructions for receiving, from the second UE, an indication of a pathloss between the first UE and the second UE, where the pathloss may be based on a fraction of the second transmit power used at the second UE for energy harvesting and determining the second transmit power for the one or more energy harvesting transmissions using the indicated pathloss.

Some examples of the method, apparatuses, and non-transitory computer-readable medium described herein may further include operations, features, means, or instructions for receiving, from the second UE, an indication of a class of the second UE, identifying one or more values for determining the second transmit power for the one or more energy harvesting transmissions to the second UE based on the class of the second UE, and determining the second transmit power for the one or more energy harvesting transmissions using a first value of the one or more values.

Some examples of the method, apparatuses, and non-transitory computer-readable medium described herein may further include operations, features, means, or instructions for receiving, from the second UE, feedback on the second transmit power used for the one or more energy harvesting transmissions and determining an updated transmit power for subsequent energy harvesting transmissions to the second UE using a second value of the one or more values based on the received feedback.

In some examples of the method, apparatuses, and non-transitory computer-readable medium described herein, each of the first configuration and the second configuration includes one or more parameters including one or more of a maximum power, a maximum power based on a channel busy ratio, a sidelink transmission power, or an amount of interference at a destination device.

A method for wireless communication at a second UE is described. The method may include transmitting, to a first UE, an indication of a transmit power for one or more energy harvesting transmissions from the first UE to the second UE, receiving, from the first UE, the one or more energy harvesting transmissions at the indicated transmit power based on transmitting the indication of the transmit power, and performing, at the second UE, energy harvesting based on receiving the one or more energy harvesting transmissions at the indicated transmit power.

An apparatus for wireless communication at a second UE is described. The apparatus may include a processor, memory coupled with the processor, and instructions stored in the memory. The instructions may be executable by the processor to cause the apparatus to transmit, to a first UE, an indication of a transmit power for one or more energy harvesting transmissions from the first UE to the second UE, receive, from the first UE, the one or more energy harvesting transmissions at the indicated transmit power based on transmitting the indication of the transmit power, and perform, at the second UE, energy harvesting based on receiving the one or more energy harvesting transmissions at the indicated transmit power.

Another apparatus for wireless communication at a second UE is described. The apparatus may include means for transmitting, to a first UE, an indication of a transmit power for one or more energy harvesting transmissions from the first UE to the second UE, means for receiving, from the first UE, the one or more energy harvesting transmissions at the indicated transmit power based on transmitting the indication of the transmit power, and means for performing, at the second UE, energy harvesting based on receiving the one or more energy harvesting transmissions at the indicated transmit power.

A non-transitory computer-readable medium storing code for wireless communication at a second UE is described. The code may include instructions executable by a processor to transmit, to a first UE, an indication of a transmit power for one or more energy harvesting transmissions from the first UE to the second UE, receive, from the first UE, the one or more energy harvesting transmissions at the indicated transmit power based on transmitting the indication of the transmit power, and perform, at the second UE, energy harvesting based on receiving the one or more energy harvesting transmissions at the indicated transmit power.

In some examples of the method, apparatuses, and non-transitory computer-readable medium described herein, transmitting the indication of the transmit power may include operations, features, means, or instructions for transmitting, to the first UE, an indication of a value for determining the transmit power for the one or more energy harvesting transmissions, where receiving the one or more energy harvesting transmissions at the indicated transmit power may be based on transmitting the indication of the value.

Some examples of the method, apparatuses, and non-transitory computer-readable medium described herein may further include operations, features, means, or instructions for transmitting, to the first UE, feedback associated with the transmit power used for the one or more energy harvesting transmissions and receiving subsequent energy harvesting transmissions from the first UE at an updated transmit power based on transmitting the feedback.

In some examples of the method, apparatuses, and non-transitory computer-readable medium described herein, the indicated value may be based on a quality of service level associated with the one or more energy harvesting transmissions.

In some examples of the method, apparatuses, and non-transitory computer-readable medium described herein, transmitting the indication of the transmit power may include operations, features, means, or instructions for transmitting, to the first UE, an indication of an alpha value for the first UE to use to determine the transmit power for the one or more energy harvesting transmissions based on a fraction of the transmit power used at the second UE for energy harvesting, where receiving the one or more energy harvesting transmissions at the indicated transmit power may be based on transmitting the indication of the alpha value.

Some examples of the method, apparatuses, and non-transitory computer-readable medium described herein may further include operations, features, means, or instructions for transmitting, to the first UE, an indication of a pathloss between the first UE and the second UE based on a fraction of the transmit power used at the second UE for energy harvesting, where receiving the one or more energy harvesting transmissions at the indicated transmit power may be based on transmitting the indication of the pathloss.

In some examples of the method, apparatuses, and non-transitory computer-readable medium described herein, transmitting the indication of the transmit power may include operations, features, means, or instructions for transmitting, to the first UE, an indication of a class of the second UE, where receiving the one or more energy harvesting transmissions at the indicated transmit power may be based on transmitting the indication of the class of the second UE.

Some examples of the method, apparatuses, and non-transitory computer-readable medium described herein may further include operations, features, means, or instructions for transmitting, to the first UE, feedback on the transmit power used for the one or more energy harvesting transmissions and receiving subsequent energy harvesting transmissions from the first UE at an updated transmit power based on transmitting the feedback.

A method for wireless communication at a first UE is described. The method may include receiving, from a second UE, one or more transmissions for assisting the first UE in setting a transmit power for one or more energy harvesting transmissions to the second UE, determining the transmit power for the one or more energy harvesting transmissions based on the one or more transmissions, and transmitting, to the second UE, the one or more energy harvesting transmissions using the determined transmit power.

An apparatus for wireless communication at a first UE is described. The apparatus may include a processor, memory coupled with the processor, and instructions stored in the memory. The instructions may be executable by the processor to cause the apparatus to receive, from a second UE, one or more transmissions for assisting the first UE in setting a transmit power for one or more energy harvesting transmissions to the second UE, determine the transmit power for the one or more energy harvesting transmissions based on the one or more transmissions, and transmit, to the second UE, the one or more energy harvesting transmissions using the determined transmit power.

Another apparatus for wireless communication at a first UE is described. The apparatus may include means for receiving, from a second UE, one or more transmissions for assisting the first UE in setting a transmit power for one or more energy harvesting transmissions to the second UE, means for determining the transmit power for the one or more energy harvesting transmissions based on the one or more transmissions, and means for transmitting, to the second UE, the one or more energy harvesting transmissions using the determined transmit power.

A non-transitory computer-readable medium storing code for wireless communication at a first UE is described. The code may include instructions executable by a processor to receive, from a second UE, one or more transmissions for assisting the first UE in setting a transmit power for one or more energy harvesting transmissions to the second UE, determine the transmit power for the one or more energy harvesting transmissions based on the one or more transmissions, and transmit, to the second UE, the one or more energy harvesting transmissions using the determined transmit power.

In some examples of the method, apparatuses, and non-transitory computer-readable medium described herein, receiving the one or more transmissions may include operations, features, means, or instructions for receiving sounding reference signals from the second UE.

Some examples of the method, apparatuses, and non-transitory computer-readable medium described herein may further include operations, features, means, or instructions for performing one or more measurements on the sounding reference signals, where the determining the transmit power may be based on performing the one or more measurements.

In some examples of the method, apparatuses, and non-transitory computer-readable medium described herein, receiving the one or more transmissions may include operations, features, means, or instructions for receiving, from the second UE, feedback on a previous transmit power used for a previous energy harvesting transmission, where determining the transmit power for the one or more energy harvesting transmissions may be based on the received feedback.

In some examples of the method, apparatuses, and non-transitory computer-readable medium described herein, receiving the one or more transmissions may include operations, features, means, or instructions for receiving, from the second UE, sounding reference signals and feedback on a previous transmit power used for a previous energy harvesting transmission.

Some examples of the method, apparatuses, and non-transitory computer-readable medium described herein may further include operations, features, means, or instructions for performing one or more measurements on the sounding reference signals, where determining the transmit power for the one or more energy harvesting transmissions includes and determining the transmit power for the one or more energy harvesting transmissions based on the one or more measurements and the received feedback.

In some examples of the method, apparatuses, and non-transitory computer-readable medium described herein, the sounding reference signals and the feedback may be time division multiplexed or frequency division multiplexed.

A method for wireless communication at a second UE is described. The method may include transmitting, to a first UE, one or more transmissions for assisting the first UE in setting a transmit power for one or more energy harvesting transmissions to the second UE, receiving, from the first UE, the one or more energy harvesting transmissions at the transmit power based on transmitting the one or more transmissions, and performing, at the second UE, energy harvesting based on receiving the one or more energy harvesting transmissions at the transmit power.

An apparatus for wireless communication at a second UE is described. The apparatus may include a processor, memory coupled with the processor, and instructions stored in the memory. The instructions may be executable by the processor to cause the apparatus to transmit, to a first UE, one or more transmissions for assisting the first UE in setting a transmit power for one or more energy harvesting transmissions to the second UE, receive, from the first UE, the one or more energy harvesting transmissions at the transmit power based on transmitting the one or more transmissions, and perform, at the second UE, energy harvesting based on receiving the one or more energy harvesting transmissions at the transmit power.

Another apparatus for wireless communication at a second UE is described. The apparatus may include means for transmitting, to a first UE, one or more transmissions for assisting the first UE in setting a transmit power for one or more energy harvesting transmissions to the second UE, means for receiving, from the first UE, the one or more energy harvesting transmissions at the transmit power based on transmitting the one or more transmissions, and means for performing, at the second UE, energy harvesting based on receiving the one or more energy harvesting transmissions at the transmit power.

A non-transitory computer-readable medium storing code for wireless communication at a second UE is described. The code may include instructions executable by a processor to transmit, to a first UE, one or more transmissions for assisting the first UE in setting a transmit power for one or more energy harvesting transmissions to the second UE, receive, from the first UE, the one or more energy harvesting transmissions at the transmit power based on transmitting the one or more transmissions, and perform, at the second UE, energy harvesting based on receiving the one or more energy harvesting transmissions at the transmit power.

In some examples of the method, apparatuses, and non-transitory computer-readable medium described herein, transmitting the one or more transmissions may include operations, features, means, or instructions for transmitting sounding reference signals to the first UE, where receiving the one or more energy harvesting transmissions at the transmit power may be based on transmitting the sounding reference signals.

In some examples of the method, apparatuses, and non-transitory computer-readable medium described herein, transmitting the one or more transmissions may include operations, features, means, or instructions for transmitting, to the first UE, feedback on a previous transmit power used for a previous energy harvesting transmission, where receiving the one or more energy harvesting transmissions at the transmit power may be based on transmitting the feedback.

In some examples of the method, apparatuses, and non-transitory computer-readable medium described herein, transmitting the one or more transmissions may include operations, features, means, or instructions for transmitting, to the first UE, sounding reference signals and feedback on a previous transmit power used for a previous energy harvesting transmission, where receiving the one or more energy harvesting transmissions at the transmit power may be based on transmitting the sounding reference signals and the feedback.

In some examples of the method, apparatuses, and non-transitory computer-readable medium described herein, the sounding reference signals and the feedback may be time division multiplexed or frequency division multiplexed.

### BRIEF DESCRIPTION OF THE DRAWINGS

FIG. 1 illustrates an example of a wireless communications system that supports power control for charging user equipment (UE) and wearables in accordance with aspects of the present disclosure.

FIGS. 2A and 2B illustrate examples of circuitry at a UE that supports energy harvesting at the UE in accordance with aspects of the present disclosure.

FIG. 3 illustrates an example of different energy harvesting schemes in accordance with aspects of the present disclosure.

FIG. 4 illustrates an example of energy harvesting signaling in accordance with aspects of the present disclosure.

FIG. 5 illustrates an example of a wireless communications system that supports power control for charging UEs and wearables in accordance with aspects of the present disclosure.

FIG. 6 illustrates an example of resource (e.g., slot) structures that support power control for charging UEs and wearables in accordance with aspects of the present disclosure.

FIG. 7 illustrates an example of a process flow that supports power control for charging UEs and wearables in accordance with aspects of the present disclosure.

FIGS. 8 and 9 show block diagrams of devices that support power control for charging UEs and wearables in accordance with aspects of the present disclosure.

FIG. 10 shows a block diagram of a communications manager that supports power control for charging UEs and wearables in accordance with aspects of the present disclosure.

FIG. 11 shows a diagram of a system including a device that supports power control for charging UEs and wearables in accordance with aspects of the present disclosure.

FIGS. 12 through 15 show flowcharts illustrating methods that support power control for charging UEs and wearables in accordance with aspects of the present disclosure.

### DETAILED DESCRIPTION

Some wireless communications systems may support energy harvesting at a user equipment (UE) to facilitate wireless charging of the UE. An energy harvesting circuit at the UE may receive energy harvesting signals from a base station or a UE and may draw energy from the signals for charging. In some cases, UEs in a wireless communications system may be configured to transmit energy harvesting signals to other UEs if, for example, the other UEs are outside a range of one or more base stations. In such cases, it may be appropriate for a first UE to determine an appropriate transmit power for energy harvesting transmissions to a second UE. The transmit power for the energy harvesting transmissions may be based on a quality of service (QOS) requirement for energy harvesting, a desired charging rate, etc. However, it may be challenging for the first UE to determine the appropriate transmit power for the energy harvesting transmissions (e.g., since power control defined for uplink transmissions or sidelink transmissions may not be appropriate for energy harvesting transmissions).

As described herein, a wireless communications system may support efficient techniques for determining a transmit power for energy harvesting transmissions. A transmitting UE may receive different configurations for determining a first transmit power for data transmissions and a second transmit power for energy harvesting transmissions. The different configurations may include different parameters for determining (e.g., calculating) the first transmit power and the second transmit power. In some aspects, the transmitting UE may also receive an indication of the second transmit power from a receiving UE such that the second transmit power may be determined in accordance with the capabilities of the receiving UE (e.g., based on an energy harvesting circuit at the UE). The indication of the second transmit power may be an indication of one or more parameters used to determine (e.g., calculate) the second transmit power. The transmitting UE may then transmit the data transmissions using the first transmit power and transmit the energy harvesting transmission using the second transmit power to improve the efficiency of energy harvesting at the receiving UE.

Aspects of the disclosure are initially described in the context of wireless communications systems. Examples of processes and signaling exchanges that support power control for charging UEs and wearables are then described. Aspects of the disclosure are further illustrated by and described with reference to apparatus diagrams, system diagrams, and flowcharts that relate to power control for charging UEs and wearables.

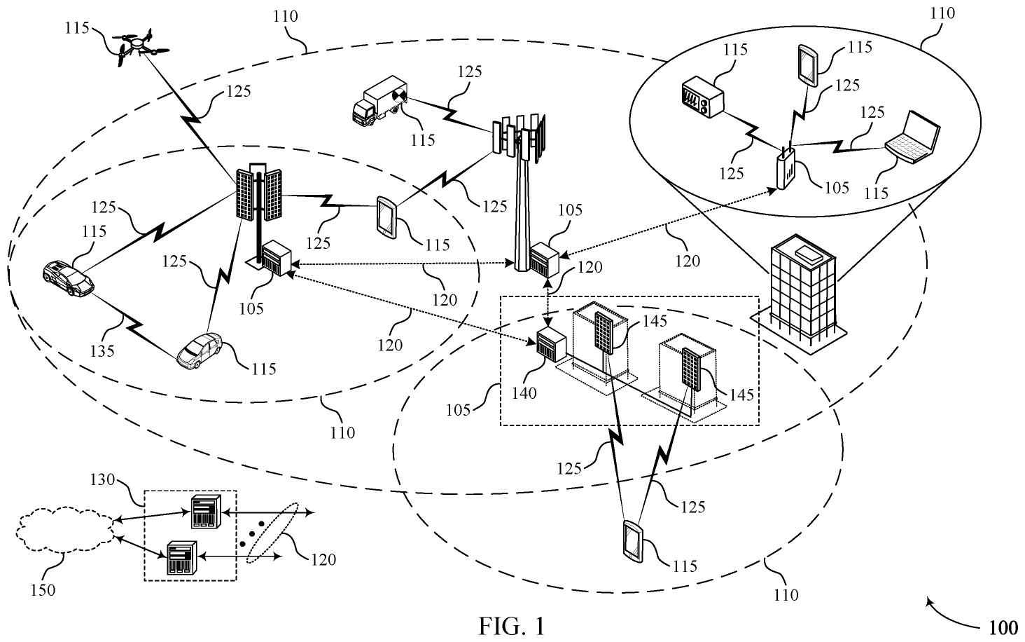

FIG. 1 illustrates an example of a wireless communications system 100 that supports power control for charging UEs and wearables in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink control channel (PUCCH) or a physical uplink shared channel (PUSCH), or downlink transmissions from a base station 105 to a UE 115 (e.g., in a physical downlink control channel (PDCCH) or a physical downlink shared channel (PDSCH)). Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). The D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHZ.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The wireless communications system 100 may utilize both unshared (e.g., licensed) and shared (e.g., unlicensed) radio frequency spectrum bands. For example, the wireless communications system 100 may employ License Assisted Access (LAA), LTE-Unlicensed (LTE-U) radio access technology, or NR technology in an unlicensed band (NR-U) such as the 5 GHz industrial, scientific, and medical (ISM) band. When operating in unlicensed radio frequency spectrum bands, devices such as the base stations 105 and the UEs 115 may employ carrier sensing for collision detection and avoidance. For example, the base stations 105 and the UEs 115 may employ LBT procedures to ensure a frequency channel (e.g., an LBT subchannel or a frequency band that is accessible via an LBT procedure) is clear before transmitting data. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

As mentioned above, UEs 115 may communicate with each other over a D2D communication link 135. The D2D communication link 135 may be referred to as a sidelink. Sidelink communications may take place in transmission or reception resource pools. A minimum resource allocation unit for sidelink communications may be a sub-channel in a frequency domain, and a resource allocation in a time domain for sidelink communications may be one slot. Some slots may not be available for sidelink, and some slots may contain feedback resources. In some aspects, an RRC configuration for sidelink communications may be preconfigured (e.g., preloaded on a UE 115) or signaled to a UE 115 (e.g., from a base station 105). In some examples, a base station 105 facilitates the scheduling of resources for sidelink communications (e.g., in a resource allocation mode 1). In other cases, sidelink communications are carried out between the UEs 115 without the involvement of a base station 105 (e.g., in a resource allocation mode 2).

UEs 115 supporting sidelink communications may be referred to as sidelink UEs 115 and may support sidelink operation, sidelink only operation, and UE-to-network relay operation. In some implementations, sidelink UEs 115 may include a smartwatch (e.g., with or without a 5G modem) or a health monitoring device connected to a smartphone. In other implementations, sidelink UEs 115 may include an extended reality (XR) head-mounted display (HMD) (XR HMD) connected to a smartphone. In yet other implementations, sidelink UEs 115 may include a sensor communicating with a smartphone or sensors communicating with each other. In some examples, sensors communicating with each other may be smart home appliances (e.g., a smart thermostat and an entry key) or mesh devices over sidelink (e.g., including UE-to-UE relays).

In some cases, sidelink communications may include communications over one or more sidelink channels. For instance, sidelink data transmissions may be over a physical sidelink shared channel (PSSCH), sidelink discovery expression transmissions may be over a physical sidelink discovery channel (PSDCH) (e.g., to allow proximal devices to discover each other's presence), sidelink control information transmissions may be over a physical sidelink control channel (PSCCH), sidelink feedback transmissions may be over a physical sidelink feedback channel (PSFCH), and sidelink broadcast transmissions may be over a physical sidelink broadcast channel (PSBCH). Sidelink communications may also include transmitting reference signals from one UE 115 to another UE 115. The reference signals may include demodulation reference signals (DMRSs) for PSCCH, DMRSs for PSSCH, DMRSs for PSBCH, channel state information reference signals (CSI-RSs), sidelink primary synchronization signals (S-PSSs), sidelink secondary synchronization signals (S-SSSs), or phase-tracking reference signals (PTRSs) (e.g., for FR2).

In some examples, slots used for sidelink communications may have a slot structure without feedback resources or a slot structure with feedback resources. For a slot structure without feedback resources, a slot may include 14 OFDM symbols (e.g., where sidelink may be preconfigured to occupy fewer than 14 symbols in the slot). The first symbol may be repeated on a preceding symbol for automatic gain control (AGC) settling. In some cases, a gap symbol may be present after a PSSCH. A sub-channel size may be preconfigured to 10, 15, 20, 25, 50, 75, or 100 physical resource blocks (PRBs). Further, PSCCH and PSSCH may be transmitted in a same slot. For a slot structure with feedback resources, resources for PSFCH may be configured with a period of 0, 1, 2, or 4 slots. An OFDM symbol may be dedicated to PSFCH, and the first PSFCH symbol may be a repetition of a second PSFCH symbol for AGC settling. In some cases, a gap symbol may be placed after the PSFCH symbols.

In some aspects, a UE 115 may transmit sidelink control information (SCI) to another UE 115 to facilitate sidelink communications. SCI may be transmitted in two stages for forward compatibility. A UE 115 may transmit a first stage of SCI (e.g., SCI-1) on a PSCCH, and the first stage of SCI may contain information for resource allocation and for decoding a second stage of SCI (e.g., SCI-2). The UE 115 may transmit the second stage of SCI on a PSSCH, and the second stage of SCI may contain information for decoding data (e.g., in a shared channel (SCH)). The first stage of SCI may be decodable by all UEs 115 and the second stage of SCI may be decodable by some UEs 115 (e.g., to allow features to be introduced while avoiding resource collisions). In some cases, a UE 115 may encode both the first stage of SCI and the second stage of SCI using a PDCCH polar code.

In some examples, in an in-coverage scenario, sidelink UEs 115 utilizing sidelink communications may be within a geographic coverage area 110 of a base station 105. The sidelink UEs 115 may be connected via a Uu interface with the base station 105 (e.g., a 5GC). The Uu interface may refer to an interface used for communications between a UE 115 and a base station 105 (e.g., uplink or downlink communications). In such examples, sidelink authorization and provisioning via the Uu interface may be used to support sidelink operation, and the base station 105 may control sidelink discovery and communication resource allocation. In other examples, in an out-of-coverage scenario, sidelink UEs 115 may be outside a geographic coverage area 110 of a base station 105 (e.g., may not be connected to a 5G server (5GS)). In such examples, sidelink UEs 115 may operate without authorization and provisioning via a Uu interface, and the sidelink UEs 115 may be preconfigured with sidelink provisioning information for discovery and communication support.

In yet other examples, in a partial coverage scenario, at least one sidelink UE 115 may be within a geographic coverage area 110 of a base station 105 and other sidelink UEs 115 may be outside the geographic coverage area 110 of the base station 105. The at least one sidelink UE 115 within the geographic coverage area 110 may be connected via a Uu interface to the base station 105 (e.g., a 5GC), and the other sidelink UEs 115 outside the geographic coverage area 110 may be connected to the base station 105 via the at least one sidelink UE 115 within the geographic coverage area 110 (e.g., via relay operation). In such examples, both authorization and provisioning via the Uu interface in addition to preconfigured sidelink provisioning may be possible.

Wireless communications system 100 may support energy harvesting at a UE 115 to facilitate wireless charging of the UE 115. Energy harvesting may allow for a longer battery life of a device with a battery or may be used to support devices without batteries (e.g., medical sensors, implanted sensors, etc.). An energy harvesting circuit at the UE 115 may receive energy harvesting signals from a base station 105 or a UE 115 and may draw energy from the signals for charging. In some examples, harvested energy may be used in some tasks like data decoding, data reception, data encoding, or data transmission (e.g., through the accumulation of energy over time). A device may use a dedicated battery for energy harvesting in a way that these tasks may be performed using the harvested energy. In some examples, energy harvesting may be used to charge the battery of a device (e.g., wearable smart watch, UE, low-power device, etc.). A device may be self-sustainable in a network if the device may interact with other devices in the network using energy harvested in the network through transmissions.

Energy harvesting using signals or radio frequency (RF) signals may be referred to as RF energy harvesting. Unlike energy harvesting from other sources (e.g., wind, solar, or vibrations), RF energy harvesting may be facilitated by RF sources that can provide controllable and consistent energy transfer over distances between devices for RF energy harvesters. Further, in a fixed RF energy harvesting network, harvested energy may be predictable and relatively stable over time due to a fixed distance between a transmitter and a receiver. Using a random multipath fading channel model, energy harvested at a node j from a transmitting node i may be given by Equation 1. In Equation 1, Pᵢ may be a transmit power by node i, gᵢ₋ⱼ may be a channel coefficient of a link between node i and node j. T may be a time allocated for energy harvesting, and η may be an RF-to-direct current (DC) conversion efficiency.

$${E}_{j} = η {P}_{i} {\vert {g}_{i - j} \vert}^{2} T \qquad ( 1 )$$

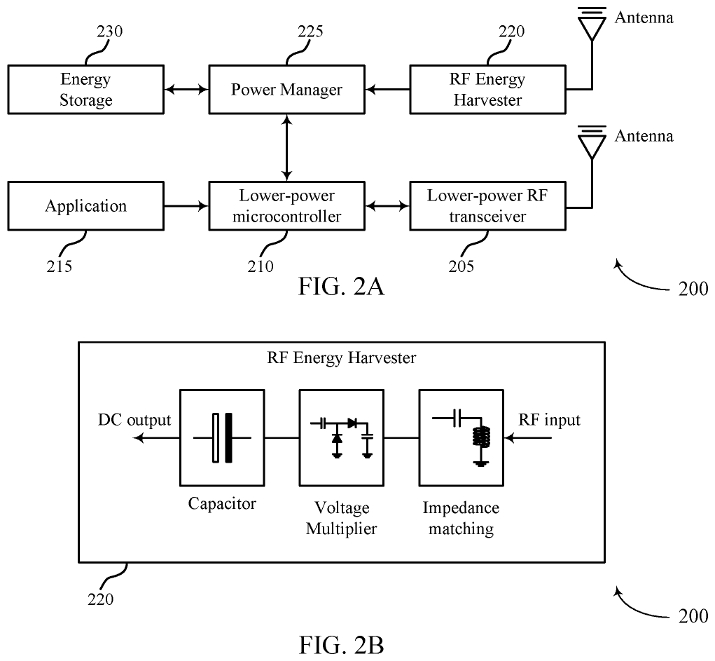

FIGS. 2A and 2B illustrate examples of circuitry 200 at a UE 115 that supports energy harvesting at the UE in accordance with aspects of the present disclosure. FIG. 2A shows a low-power RF transceiver 205 used for information transmission or reception, a low-power microcontroller 210 used to process data, and an application 215 using the information or data. FIG. 2A also shows an RF energy harvester 220 used for energy harvesting, a power manager 225 which decides whether to store electricity obtained from the RF energy harvester 220 or to use it for information transmission (e.g., immediately), and an energy storage or battery 230. FIG. 2B shows circuitry inside the RF energy harvester 220. The RF energy harvester 220 may include an RF antenna, an impedance matching circuit, a voltage multiplier, and a capacitor to collect RF signals and convert them to electricity.

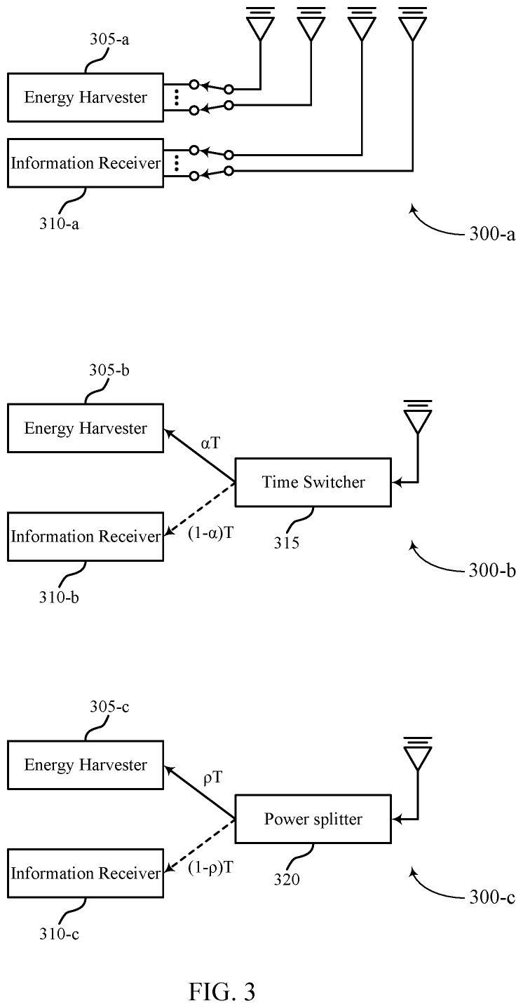

FIG. 3 illustrates an example of different energy harvesting schemes 300 in accordance with aspects of the present disclosure. A first example scheme 300-a illustrates aspects of a separated receiver architecture for energy harvesting. The separated receiver architecture may include an energy harvester 305-a and an information receiver 310-a, and the energy harvester 305-a may be connected to different antennas from the information receiver 310-a. A second example scheme 300-b illustrates aspects of a time-switching architecture for energy harvesting. The time-switching architecture may include an energy harvester 305-b, an information receiver 310-b, and a time switcher 315. A third example scheme 300-c illustrates aspects of a power-splitting architecture for energy harvesting. The power-splitting architecture may include an energy harvester 305-c, an information receiver 310-c, and a power splitter 320.

The time-switching architecture may allow a node (e.g., network node, such as a UE 115) to switch between the energy harvester 305-b and the information receiver 310-b. In some cases, energy harvested at a receiver j from a source i may be calculated using Equation 2. In Equation 2, 0≤α≤1 may be a fraction of time allocated for energy harvesting.

$${E}_{j} = η {P}_{i} {\vert {g}_{i - j} \vert}^{2} α T \qquad ( 2 )$$

In some examples, a data rate for communications using the time-switching architecture may be given by Equation 3. In Equation 3, κ may denote a noise spectral density and W may denote a channel bandwidth.

$${R}_{i - j} = ( 1 - α ) {log}_{2} ( 1 + \frac{{\vert {g}_{i - j} \vert}^{2} {P}_{i}}{κ W} ) \qquad ( 3 )$$

In the power-splitting architecture, received RF signals may be split into two streams for the energy harvester 305-c and the information receiver 310-c with different power levels. In some cases, energy harvested at a receiver j from a source i may be calculated using Equation 4. In Equation 4, 0≤ρ≤1 may be a fraction of power allocated for energy harvesting.

$${E}_{j} = ηρ {P}_{i} {\vert {g}_{i - j} \vert}^{2} T \qquad ( 4 )$$

In some examples, a data rate for communications using the power-switching architecture may be given by Equation 5. In Equation 5, κ may denote a noise spectral density and W may denote a channel bandwidth.

$${R}_{i - j} = {log}_{2} ( 1 + \frac{{\vert {g}_{i - j} \vert}^{2} ( 1 - ρ ) {P}_{i}}{κ W} ) \qquad ( 5 )$$

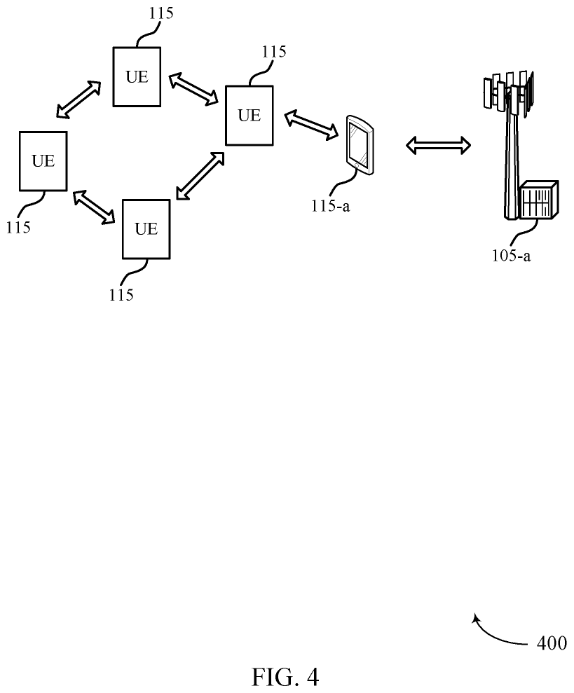

FIG. 4 illustrates an example of energy harvesting signaling 400 in accordance with aspects of the present disclosure. In FIG. 4, a UE 115-a may be configured to transmit energy harvesting signals to facilitate energy harvesting at other UEs 115 (e.g., small, low-power devices) if, for example, the UEs 115 are outside a range of a base station 105-a. For instance, since the base station 105-a may not be able to reach every device in a network, and the network may support sidelink communications and communications over a Uu interface (e.g., uplink and downlink communications), the base station 105-a may instruct UE 115-a (or another device) to perform dedicated power transfer tasks to other devices (e.g., the other UEs 115). In some cases, UE 115-a may transmit an indication to the base station 105-a that UE 115-a is capable of using energy harvesting waveforms and may participate in energy transfer tasks. The base station 105-a may then instruct UE 115-a to power the other UEs 115 over a set of time and frequency resources.

In order to facilitate efficient energy harvesting at the other UEs 115 and maintain a wireless charging rate at the other UEs 115, it may be appropriate for UE 115-a to transmit energy harvesting signals to the other UEs 115 with appropriate power. Thus, efficient techniques for power control at UE 115-a may be desirable (e.g., when UE 115-a is assigned the task of charging the other UEs 115). In some cases, power charging may be a Qos requirement in a network and may be based on a charging rate required by a power or energy receiving UE 115 (e.g., a wearable) and an ability of a power or energy transmitting UE 115 to charge the receiving UE 115 (e.g., power control at the transmitting UE 115 may be decided and managed).

In some aspects, an energy harvester (e.g., energy harvesting circuit) at a receiving UE may have a piece-wise linear energy harvester mode. The model may be linear below a threshold and saturate after the threshold (e.g., the energy harvester may have one or more non-linearities). For example, an input power to an energy harvesting circuit at the receiving UE 115 and an output power from the energy harvesting circuit at the receiving UE 115 may be linear if the input power is below a threshold power (Pₜₕ). Otherwise, if the input power exceeds the threshold power, the output power may not exceed beyond the output power generated from the threshold power (e.g., the model saturates). The input power that may support a target charging rate may be referred to as Pin (e.g., input to an energy harvesting circuit), and an output power that may satisfy the target charging rate may be referred to as Pout (e.g., output from an energy harvesting circuit). If the input power is less than the threshold power in accordance with equation 6, then the harvested energy is given by Equation 7. If the input power is greater than or equal to the threshold power in accordance with equation 8, then the harvested energy is given by Equation 9.

$${P}_{i} {\vert {g}_{i - j} \vert}^{2} < {P}_{th} \qquad ( 6 )$$

$${E}_{j} = η {P}_{i} {\vert {g}_{i - j} \vert}^{2} T \qquad ( 7 )$$

$${P}_{i} {\vert {g}_{i - j} \vert}^{2} \geq {P}_{th} \qquad ( 8 )$$

$${E}_{j} = η {P}_{th} T \qquad ( 9 )$$

In some cases, a target charging rate (Pout) at a receiving device may depend on an energy harvesting scheme (e.g., a type of energy harvesting) implemented at the receiving device. If the receiving device uses power-splitting energy harvesting, the target charging rate may depend on circuitry efficiency (e.g., which may be a function of the input power) as well as the power-splitting factor, p. For other types of energy harvesting, the target charging rate may be a function of the circuitry efficiency (e.g., which may be a function of the input power). Given an input power, Pin, a power or energy transmitting node (e.g., a UE 115, a base station 105, a customer-premises equipment (CPE), or other devices) may adjust its power control based on the target charging rate.

In wireless communications system 100, a UE 115 may support power control for uplink communications and sidelink communications. If the UE 115 transmits a PUSCH on an active uplink bandwidth part (BWP) b of carrier f of serving cell c using parameter set configuration with index j and PUSCH power control adjustment state with index l, the UE 115 may determine the PUSCH transmission power P_{PUSCH,b,f,c}(i,j,q_{d},l) in PUSCH transmission occasion i using Equation 10. Equation 10 may be referred to as the Uu PUSCH power control equation. In Equation 10, P_{CMAX,f,c}(i) may be a UE configured maximum output power for carrier f of serving cell c in PUSCH transmission i.

$${P}_{PUSCH , b , f , c} ( i , j , {q}_{d} , l ) = \qquad ( 10 )$$

$$min ( \begin{matrix}{P}_{CMAX , f , c} ( i ) \\ \begin{matrix}{P}_{0 \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} )$$

In some cases, the UE 115 may determine a transmit power for transmitting sounding reference signals (SRSs) using Equation 11.

$${P}_{SRS , b , f , c} ( i , {q}_{s} , l ) = min ( \begin{matrix}{P}_{CMAX , f , c} ( i ) \\ \begin{matrix}{P}_{0 \_ SRS , b , f , c} ( j ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} ) \qquad ( 11 )$$

If a base station 105 indicates a same power state for both SRS and PUSCH (e.g., via an srs-PowerControlAdjustmentStates field), the SRS power control adjustment h_{b,f,c}(i,l) may be equal to f_{b,f,c}(i,l).

In some cases, a UE 115 may determine a power P_{PSSCH,b,c}(i) for a PSSCH transmission on a resource pool in symbols where a corresponding PSCCH is not transmitted in PSCCH-PSSCH transmission occasion i using Equation 12.

$${P}_{PSSCH} ( i ) = min ( {P}_{CMAX} , {P}_{MAX , CBR} , min ( {P}_{PSSCH , D} ( i ) , {P}_{PSSCH , SL} ( i ) ) ) \qquad ( 12 )$$

In Equation 12, P_{CMAX} may be a UE configured maximum output power and P_{MAX,CBR} may be determined by a value of sl-MaxTransPower based on a priority level of the PSSCH transmission and a constant bit rate (CBR) range that includes a CBR measured in slot i-N. In some cases, if sl-MaxTransPower is not provided then P_{MAX,CBR}=P_{CMAX}. If an element dl-P0-PSSCH-PSCCH is provided to the UE 115, then P_{PSSCH,D} is determined using Equation 13. In Equation 13, P_{O,D} may be the value of dl-P0-PSSCH-PSCCH.

$${P}_{PSSCH , D} ( i ) = {P}_{O , D} + 10 {log}_{10} ( {2}^{μ} \cdot {M}_{RB}^{PSSCH} ( i ) ) + {α}_{D} \cdot {PL}_{D} \qquad ( 13 )$$

In some cases, although a UE 115 may use the equations described above to determine a transmit power for uplink transmissions or sidelink transmissions, it may be challenging for the UE to determine an appropriate transmit power for energy harvesting transmissions. That is, power control defined for uplink transmissions or sidelink transmissions may not be appropriate for energy harvesting transmissions. Wireless communications system 100 may support efficient techniques for determining a transmit power for energy harvesting transmissions. A transmitting UE may receive different configurations for determining a first transmit power for data transmissions (e.g., uplink data transmissions or sidelink data transmissions) and a second transmit power for energy harvesting transmissions. The different configurations may include different parameters for determining (e.g., calculating) the first transmit power and the second transmit power (e.g., using the same equations, such as Equation 10 or Equation 11).

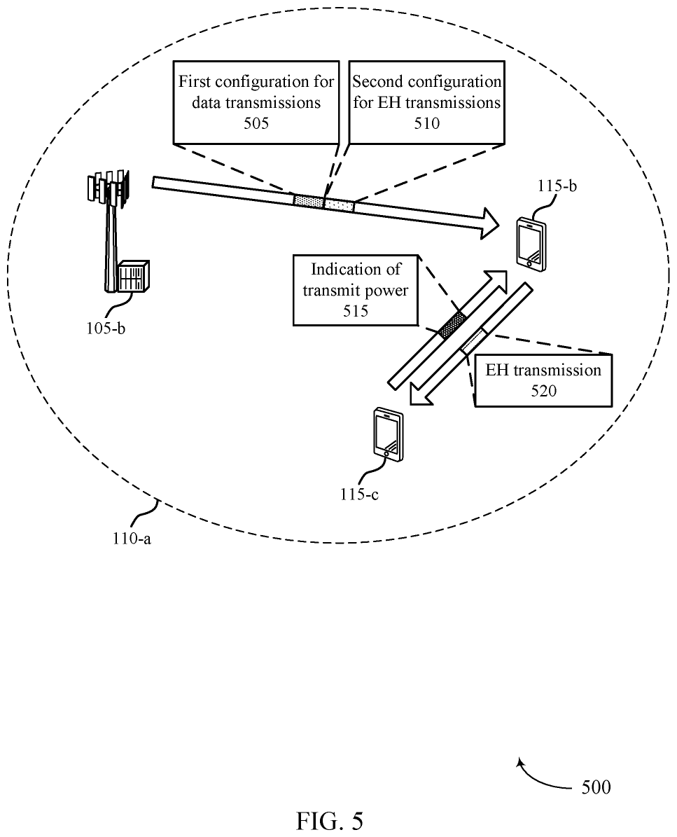

FIG. 5 illustrates an example of a wireless communications system 500 that supports power control for charging UEs and wearables in accordance with aspects of the present disclosure. The wireless communications system 500 includes a UE 115-b and a UE 115-c, which may be examples of UEs 115 described with reference to FIGS. 1-4. The wireless communications system 500 also includes a base station 105-b, which may be an example of a base station 105 described with reference to FIGS. 1-4. The base station 105-b may provide communication coverage for UEs 115 in a geographic coverage area 110-a, which may be an example of a geographic coverage area 110 described with reference to FIG. 1. The wireless communications system 500 may support efficient techniques for determining a transmit power for energy harvesting transmissions.

Base station 105-b may transmit a first configuration (e.g., transmit power configuration) to UE 115-b for determining a first transmit power for data transmissions, and the base station 105-b may transmit a second configuration to UE 115-b for determining a second transmit power for energy harvesting transmissions. Each of these configurations may indicate one or more different parameters for determining a transmit power. That is, the wireless communications system 500 may support different (e.g., new) parameters for energy harvesting applications. The parameters may include a maximum power, a maximum power based on a CBR, a sidelink transmission power, or an amount of interference at a destination device. For instance, P_{MAX,CBR}, Which is a function of transmission priority and CBR may also be defined for energy harvesting applications. Similarly, a maximum power limit may be defined for energy harvesting applications, where UE 115-b may set a certain power limit for energy harvesting transmissions 520 that is less than another power limit used for data transmissions.

In addition to supporting a different configuration for determining a transmit power for energy harvesting transmissions 520, UE 115-b may support techniques for determining the transmit power based on a desired charging rate at UE 115-c. In particular, UE 115-c may transmit an indication 515 of a transmit power for UE 115-b to use for energy harvesting transmissions 520 to UE 115-c. UE 115-b may then transmit the energy harvesting transmissions 520 to UE 115-c at the indicated transmit power to facilitate energy harvesting at UE 115-c.

In one aspect, UE 115-c may transmit an indication 515 of a p-naught (P₀) value for UE 115-b to use to determine the transmit power for energy harvesting transmissions. In an uplink power control equation (e.g., Equation 10), the p-naught value may correspond to a baseline required signal-to-noise ratio (SNR) level so that data can be received correctly at base station 105-b. In a similar power control equation for energy harvesting transmissions (e.g., Equation 10 with parameters from the second configuration 510), the p-naught value may correspond to a required power level in case of energy transfer to facilitate useful charging. In some cases, UE 115-c (e.g., a power or energy receiving UE 115) may not be able to monitor a power level because power may be directly going to an energy harvesting circuit at UE 115-c (e.g., for harvesting) instead of a usual demodulation chain. Thus, a charging rate at UE 115-c may be a proxy for the SNR. Specifically, the p-naught value may correspond to a charging rate at UE 115-c (e.g., instead of an SNR). In some examples, the p-naught value may be equal to a certain averaging of an input power or a function of the averaging of the input power, and UE 115-c may recommend the p-naught value to UE 115-b (e.g., through feedback).

In another aspect, UE 115-c may transmit an indication 515 of a class of UE 115-c to UE 115-b for UE 115-b to use to determine the transmit power for energy harvesting transmissions 520. The class of UE 115-c may be associated with a p-naught value, and UE 115-b may determine the p-naught value to use to determine a transmit power for the energy harvesting transmissions 520 based on the class of UE 115-c. That is, instead of UE 115-c sending a Pin or p-naught value or a quantized version of these values to UE 115-b, there may be an association between a class of UE 115-c (e.g., an energy harvesting class) and a p-naught value. In an initial operation for setting the p-naught value, UE 115-c may transmit the indication 515 of the class of UE 115-c (e.g., announce its class), and the class of UE 115-c may be associated with a p-naught value or a set or list of p-naught values.

As an example, a first p-naught value or first list of p-naught values may be associated with a first class of UEs 115 (e.g., class A), a second p-naught value or second list of p-naught values may be associated with a second class of UEs 115 (e.g., class B), a third p-naught value or third list of p-naught values may be associated with a third class of UEs 115 (e.g., class C), and a fourth p-naught value or fourth list of p-naught values may be associated with a fourth class of UEs 115 (e.g., class D). The class of UE 115-c may be a function of characteristics of an energy harvesting circuit at UE 115-c (e.g., a power input-output relationship among other characteristics). In some cases, the p-naught value may change over time via feedback from UE 115-c, and an updated p-naught value may be set to any value of one or more dedicated values defined per class (e.g., defined for the class of UE 115-c). For instance, UE 115-c may transmit feedback on a transmit power used for the energy harvesting transmissions 520, and UE 115-b may identify a different p-naught value for updating a transmit power for subsequent energy harvesting transmissions to UE 115-c from a set of one or more p-naught values associated with the class of UE 115-c.

In yet another aspect, UE 115-c may transmit an indication 515 of an alpha value to UE 115-b for UE 115-b to use to determine the transmit power for energy harvesting transmissions 520. Additionally, or alternatively, base station 105-b may transmit an indication of the alpha value to UE 115-b, or UE 115-b may identify the alpha value autonomously (e.g., without signaling from UE 115-c or base station 105-b). The alpha value may be based on a fraction of a transmit power used at UE 115-c for energy harvesting. In yet another aspect, UE 115-c may transmit an indication 515 of a pathloss between UE 115-b and UE 115-c to UE 115-b, and the indicated pathloss may be based on a fraction of the transmit power used at UE 115-c for energy harvesting. The techniques for indicating the alpha value or the pathloss value to UE 115-b based on the fraction of the transmit power used at UE 115-c for energy harvesting may be supported if UE 115-c utilizes power-splitting energy harvesting.

For power-splitting energy harvesting, to unify a procedure of energy harvesting (e.g., for different types of energy harvesting, such as power-splitting energy harvesting and time-splitting energy harvesting), UE 115-c may transmit an indication 515 of a p-naught value to UE 115-b without factoring a contribution of power-splitting (e.g., without factoring the power-slitting factor ρ that contributes to Pin at UE 115-c). Instead, the contribution of the power-splitting may be associated with pathloss (e.g., directly through the pathloss parameter in a power equation or indirectly through an alpha value used to scale the pathloss parameter in the power equation).

UE 115-b may transmit reference signals to UE 115-c, and UE 115-c may determine a pathloss between UE 115-b and UE 115-c based on the reference signals. In particular, UE 115-c may measure a reference signal received power (RSRP) of the reference signals and determine the pathloss between UE 115-b and UE 115-c based on the RSRP measurements. However, because UE 115-c may use power-splitting energy harvesting, a portion of the power of the reference signals may be siphoned off by the energy harvester at UE 115-c for energy harvesting. Thus, the measured RSRP used to determine the pathloss may be different from (e.g., lower than) an actual RSRP of the reference signals due to the power-splitting (e.g., based on a power-splitting factor). As such, it may be appropriate to compensate for the different RSRP when performing power control. More specifically, because a power equation used by UE 115-b to determine a transmit power for the energy harvesting transmissions 520 may be based on a pathloss between UE 115-b and UE 115-c, it may be appropriate to compensate for the pathloss being determined at UE 115-c after siphoning off a portion of the power of the reference signals for energy harvesting.

A compensation factor may be configured and may be a function of the settings of an energy harvester at UE 115-c (e.g., the fraction of the reference signals being siphoned off for energy harvesting or some other setting). In one example, instead of setting an alpha value in an equation used to determine the transmit power for the energy harvesting transmissions 520 to a value between zero and one, UE 115-b may compensate for a fraction of the measured pathloss and set the alpha value to a value greater than one to account for the measured pathloss being different from a true pathloss (e.g., due to energy of reference signals used to determine the pathloss being siphoned off for energy harvesting). In some cases, UE 115-c may transmit adjustment information (e.g., an alpha value or pathloss value) to UE 115-b to compensate for the fraction of the reference signals siphoned off for energy harvesting at UE 115-c. UE 115-b may then adjust a transmit power for energy harvesting transmission 520 to satisfy a target charging rate at UE 115-c (e.g., based on the adjustment information).

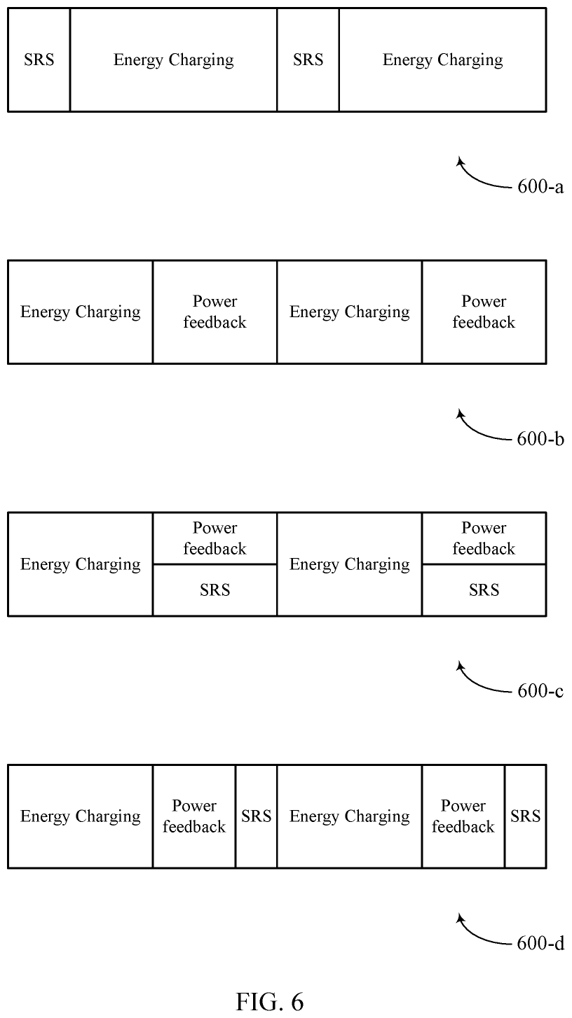

FIG. 6 illustrates an example of resource (e.g., slot) structures 600 that support power control for charging UEs and wearables in accordance with aspects of the present disclosure.

In the example slot structure 600-a, UE 115-c may transmit SRSs to UE 115-b, and UE 115-b may transmit energy harvesting transmissions (e.g., long transmission of energy) to UE 115-c based on the SRSs. The SRS transmission may correspond to a transmission of assistance information or a transmission for assisting UE 115-b in setting a transmit power for the energy harvesting transmissions to UE 115-c. In particular, UE 115-b may receive the SRSs and may perform measurements on the SRSs to determine the transmit power for the energy harvesting transmissions to UE 115-c.

In the example slot structure 600-b, UE 115-c may transmit charging information or transmit power feedback based on a transmit power used for energy harvesting transmissions from UE 115-b to UE 115-c. That is, UE 115-c may provide feedback on the charging rate at UE 115-c to UE 115-b, and UE 115-b may use the feedback to perform power control for subsequent energy harvesting transmissions to UE 115-b (e.g., to determine an updated transmit power for subsequent energy harvesting transmissions to UE 115-c).

In the example slot structure 600-c, UE 115-c may multiplex SRSs and charging information or transmit power feedback in a frequency domain (e.g., frequency division multiplexing), and UE 115-c may transmit the SRSs and the charging information or transmit power feedback to UE 115-b. That is, UE 115-c may provide both SRSs and transmit power feedback to improve energy harvesting performance. UE 115-b may then use the SRSs and the charging information or transmit power feedback to determine a transmit power for energy harvesting transmissions to UE 115-b. In some cases, the SRSs and the transmit power feedback may have different periodicities.

In the example slot structure 600-c, UE 115-c may multiplex SRSs and charging information or transmit power feedback in a time domain (e.g., time division multiplexing), and UE 115-c may transmit the SRSs and the charging information or transmit power feedback to UE 115-b. That is, UE 115-c may provide both SRSs and transmit power feedback to improve energy harvesting performance. UE 115-b may then use the SRSs and the charging information or transmit power feedback to determine a transmit power for energy harvesting transmissions to UE 115-b. In some cases, the SRSs and the transmit power feedback may have different periodicities.

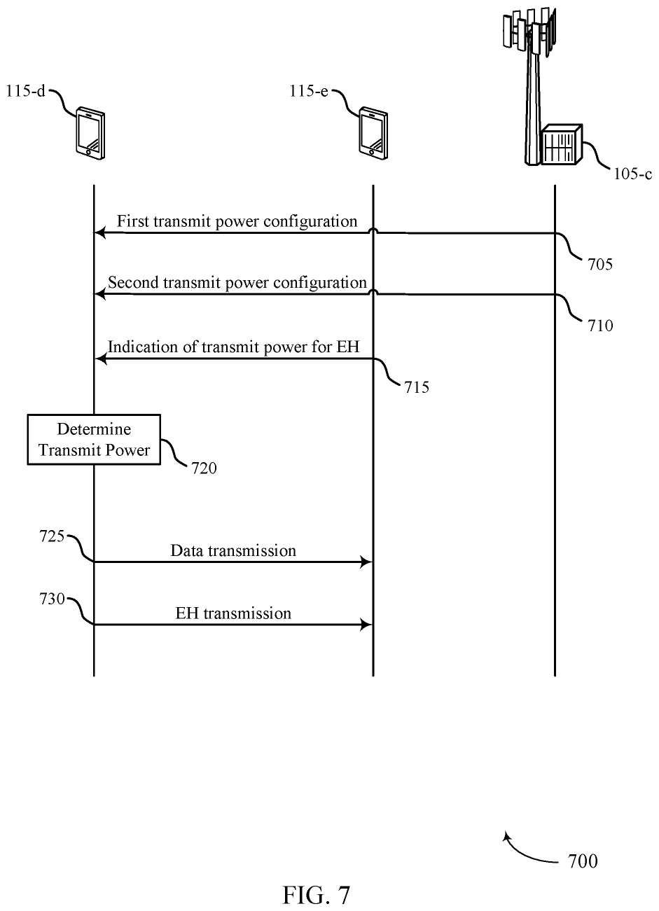

FIG. 7 illustrates an example of a process flow 700 that supports power control for charging UEs and wearables in accordance with aspects of the present disclosure. Process flow 700 includes UE 115-d and UE 115-e, which may be examples of UEs 115 described with reference to FIGS. 1-6. Process flow 700 also includes a base station 105-c, which may be an example of a base station 105 described with reference to FIGS. 1-6. The process flow 700 may implement aspects of wireless communications system 500. For example, the process flow 700 may support efficient techniques for determining a transmit power for energy harvesting transmissions.

In the following description of the process flow 700, the signaling exchanged between the UEs 115 and between the UEs 115 and the base station may be exchanged in a different order than the example order shown, or the operations performed by the UEs 115 and the base station 105 may be performed in different orders or at different times. Some operations may also be omitted from the process flow 700, and other operations may be added to the process flow 700.

At 705, UE 115-d may receive a first configuration for setting a first transmit power for one or more data transmissions, and, at 710, UE 115-d may receive a second configuration for setting a second transmit power for one or more energy harvesting transmissions. The first configuration and the second configuration may each include parameters for determining a respective transmit power for respective transmissions. In some examples, the parameters may include a maximum power, a maximum power based on a CBR, a sidelink transmission power, or an amount of interference at a destination device. At 715, UE 115-e may transmit, and UE 115-d may receive, an indication of the second transmit power for the one or more energy harvesting transmissions. The indication of the second transmit power may be an indication of one or more parameters for UE 115-d to use to determine the second transmit power.

In some cases, UE 115-e may transmit, and UE 115-d may receive, an indication of a value for determining the second transmit power for the one or more energy harvesting transmissions. The indicated value may be a p-naught value and may be based on a QoS level associated with the one or more energy harvesting transmissions. In some cases, UE 115-e or the base station 105-c may transmit, and UE 115-d may receive, an indication of an alpha value for UE 115-d to use to determine the second transmit power. The alpha value may be based on a fraction of the second transmit power used at UE 115-e for energy harvesting.

In some cases, UE 115-e may transmit, and UE 115-d may receive, an indication of a pathloss between UE 115-d and UE 115-e. The indicated pathloss may be based on the fraction of the second transmit power used at UE 115-e for energy harvesting. In some cases, UE 115-e may transmit, and UE 115-d may receive, an indication of a class of UE 115-e. In such cases, UE 115-d may identify the alpha value to use to determine the second transmit power based on the class of UE 115-e (e.g., since the class of UE 115-e may correspond to the fraction of the second transmit power used at UE 115-e for energy harvesting).

At 720, UE 115-d may determine the second transmit power for the one or more energy harvesting transmissions to UE 115-e. In some cases, UE 115-d may determine the second transmit power for the one or more energy harvesting transmissions using the value indicated by UE 115-e (e.g., a p-naught value). In some cases, UE 115-d may determine the second transmit power for the one or more energy harvesting transmissions using the alpha value. In some cases, UE 115-d may determine the second transmit power for the one or more energy harvesting transmissions using the indicated pathloss. In some cases, UE 115-d may identify one or more values for determining the second transmit power for the one or more energy harvesting transmissions based on the class of UE 115-e, and UE 115-d may determine the second transmit power for the one or more energy harvesting transmissions using a first value of the one or more values.

At 725, UE 115-d may transmit, to UE 115-e, the one or more data transmissions using the first transmit power based on receiving the first configuration at 705. At 730, UE 115-d may transmit, to UE 115-e, the one or more energy harvesting transmissions using the second transmit power based on receiving the second configuration at 710. In some cases, UE 115-e may transmit, and UE 115-d may receive, feedback associated with the one or more energy harvesting transmissions, and UE 115-d may determine an updated transmit power for subsequent energy harvesting transmissions to UE 115-e based on the received feedback. In some cases, after receiving the feedback, UE 115-d may determine the updated transmit power using a second value in the one or more values associated with the class of UE 115-e.

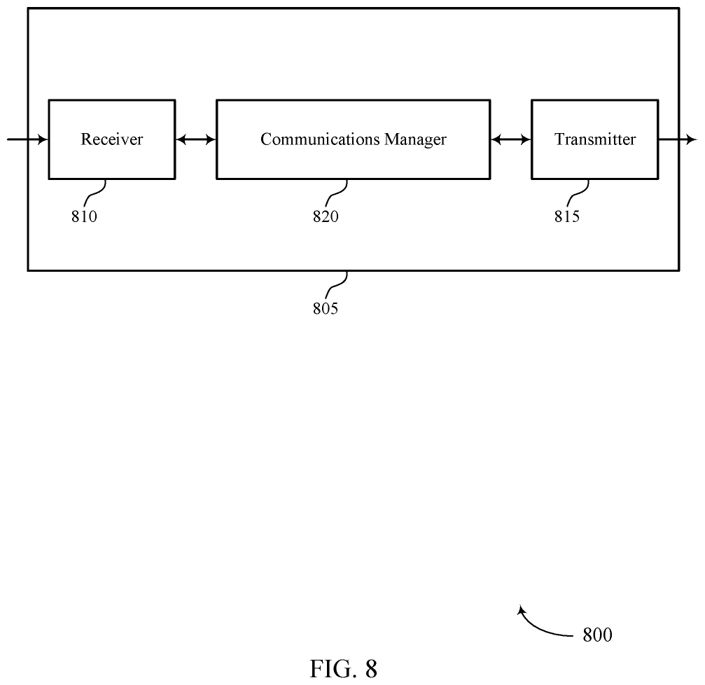

FIG. 8 shows a block diagram 800 of a device 805 that supports power control for charging UEs and wearables in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to power control for charging UEs and wearables). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to power control for charging UEs and wearables). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of power control for charging UEs and wearables as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. For example, the communications manager 820 may be configured as or otherwise support a means for receiving a first configuration for setting a first transmit power for one or more data transmissions and a second configuration for setting a second transmit power for one or more energy harvesting transmissions. The communications manager 820 may be configured as or otherwise support a means for transmitting, to a second UE, the one or more data transmissions using the first transmit power based on receiving the first configuration. The communications manager 820 may be configured as or otherwise support a means for transmitting, to the second UE, the one or more energy harvesting transmissions using the second transmit power based on receiving the second configuration.

Additionally, or alternatively, the communications manager 820 may support wireless communication at a second UE in accordance with examples as disclosed herein. For example, the communications manager 820 may be configured as or otherwise support a means for transmitting, to a first UE, an indication of a transmit power for one or more energy harvesting transmissions from the first UE to the second UE. The communications manager 820 may be configured as or otherwise support a means for receiving, from the first UE, the one or more energy harvesting transmissions at the indicated transmit power based on transmitting the indication of the transmit power. The communications manager 820 may be configured as or otherwise support a means for performing, at the second UE, energy harvesting based on receiving the one or more energy harvesting transmissions at the indicated transmit power.

Additionally, or alternatively, the communications manager 820 may support wireless communication at a first UE in accordance with examples as disclosed herein. For example, the communications manager 820 may be configured as or otherwise support a means for receiving, from a second UE, one or more transmissions for assisting the first UE in setting a transmit power for one or more energy harvesting transmissions to the second UE. The communications manager 820 may be configured as or otherwise support a means for determining the transmit power for the one or more energy harvesting transmissions based on the one or more transmissions. The communications manager 820 may be configured as or otherwise support a means for transmitting, to the second UE, the one or more energy harvesting transmissions using the determined transmit power.

Additionally, or alternatively, the communications manager 820 may support wireless communication at a second UE in accordance with examples as disclosed herein. For example, the communications manager 820 may be configured as or otherwise support a means for transmitting, to a first UE, one or more transmissions for assisting the first UE in setting a transmit power for one or more energy harvesting transmissions to the second UE. The communications manager 820 may be configured as or otherwise support a means for receiving, from the first UE, the one or more energy harvesting transmissions at the transmit power based on transmitting the one or more transmissions. The communications manager 820 may be configured as or otherwise support a means for performing, at the second UE, energy harvesting based on receiving the one or more energy harvesting transmissions at the transmit power.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improved energy harvesting and more efficient utilization of communication resources. In particular, because a first UE may be configured with different parameters for determining a transmit power for data transmissions and energy harvesting transmissions, the first UE may be able to identify a suitable power for energy harvesting transmissions to improve energy harvesting at a second UE. Further, because a first UE may receive, from a second UE, an indication of a transmit power to use for energy harvesting transmissions to the second UE, the energy harvesting transmissions from the first UE may be more useful resulting in improved energy harvesting at the second UE and more efficient utilization of resources for energy harvesting transmissions.

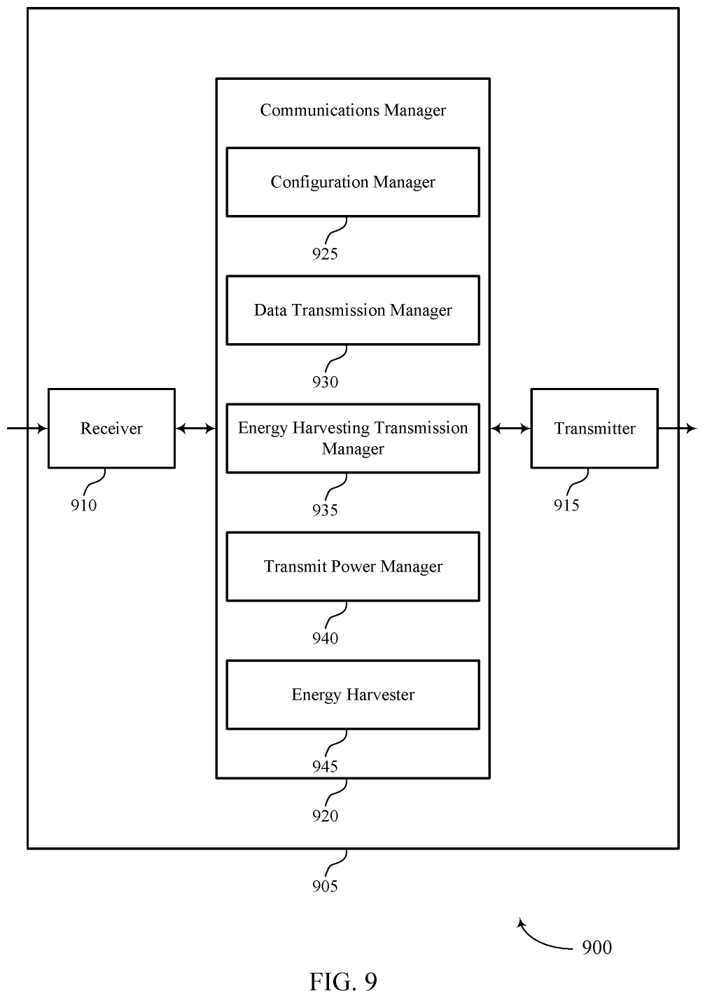

FIG. 9 shows a block diagram 900 of a device 905 that supports power control for charging UEs and wearables in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to power control for charging UEs and wearables). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to power control for charging UEs and wearables). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of power control for charging UEs and wearables as described herein. For example, the communications manager 920 may include a configuration manager 925, a data transmission manager 930, an energy harvesting transmission manager 935, a transmit power manager 940, an energy harvester 945, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first UE in accordance with examples as disclosed herein. The configuration manager 925 may be configured as or otherwise support a means for receiving a first configuration for setting a first transmit power for one or more data transmissions and a second configuration for setting a second transmit power for one or more energy harvesting transmissions. The data transmission manager 930 may be configured as or otherwise support a means for transmitting, to a second UE, the one or more data transmissions using the first transmit power based on receiving the first configuration. The energy harvesting transmission manager 935 may be configured as or otherwise support a means for transmitting, to the second UE, the one or more energy harvesting transmissions using the second transmit power based on receiving the second configuration.

Additionally, or alternatively, the communications manager 920 may support wireless communication at a second UE in accordance with examples as disclosed herein. The transmit power manager 940 may be configured as or otherwise support a means for transmitting, to a first UE, an indication of a transmit power for one or more energy harvesting transmissions from the first UE to the second UE. The energy harvester 945 may be configured as or otherwise support a means for receiving, from the first UE, the one or more energy harvesting transmissions at the indicated transmit power based on transmitting the indication of the transmit power. The energy harvester 945 may be configured as or otherwise support a means for performing, at the second UE, energy harvesting based on receiving the one or more energy harvesting transmissions at the indicated transmit power.

Additionally, or alternatively, the communications manager 920 may support wireless communication at a first UE in accordance with examples as disclosed herein. The transmit power manager 940 may be configured as or otherwise support a means for receiving, from a second UE, one or more transmissions for assisting the first UE in setting a transmit power for one or more energy harvesting transmissions to the second UE. The transmit power manager 940 may be configured as or otherwise support a means for determining the transmit power for the one or more energy harvesting transmissions based on the one or more transmissions. The energy harvesting transmission manager 935 may be configured as or otherwise support a means for transmitting, to the second UE, the one or more energy harvesting transmissions using the determined transmit power.

Additionally, or alternatively, the communications manager 920 may support wireless communication at a second UE in accordance with examples as disclosed herein. The transmit power manager 940 may be configured as or otherwise support a means for transmitting, to a first UE, one or more transmissions for assisting the first UE in setting a transmit power for one or more energy harvesting transmissions to the second UE. The energy harvester 945 may be configured as or otherwise support a means for receiving, from the first UE, the one or more energy harvesting transmissions at the transmit power based on transmitting the one or more transmissions. The energy harvester 945 may be configured as or otherwise support a means for performing, at the second UE, energy harvesting based on receiving the one or more energy harvesting transmissions at the transmit power.

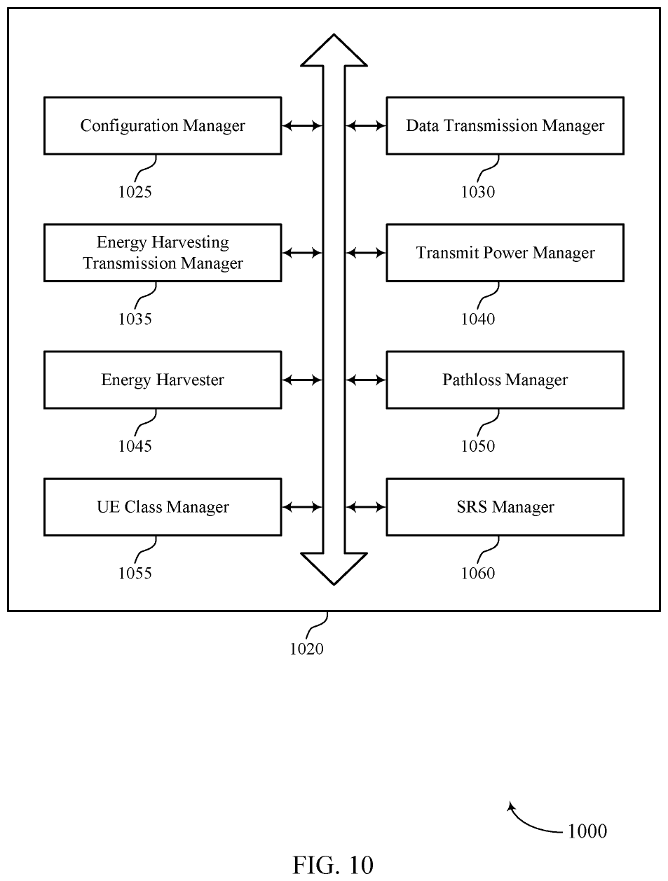

FIG. 10 shows a block diagram 1000 of a communications manager 1020 that supports power control for charging UEs and wearables in accordance with aspects of the present disclosure. The communications manager 1020 may be an example of aspects of a communications manager 820, a communications manager 920, or both, as described herein. The communications manager 1020, or various components thereof, may be an example of means for performing various aspects of power control for charging UEs and wearables as described herein. For example, the communications manager 1020 may include a configuration manager 1025, a data transmission manager 1030, an energy harvesting transmission manager 1035, a transmit power manager 1040, an energy harvester 1045, a pathloss manager 1050, a UE class manager 1055, an SRS manager 1060, or any combination thereof. Each of these components may communicate, directly or indirectly, with one another (e.g., via one or more buses).

The communications manager 1020 may support wireless communication at a first UE in accordance with examples as disclosed herein. The configuration manager 1025 may be configured as or otherwise support a means for receiving a first configuration for setting a first transmit power for one or more data transmissions and a second configuration for setting a second transmit power for one or more energy harvesting transmissions. The data transmission manager 1030 may be configured as or otherwise support a means for transmitting, to a second UE, the one or more data transmissions using the first transmit power based on receiving the first configuration. The energy harvesting transmission manager 1035 may be configured as or otherwise support a means for transmitting, to the second UE, the one or more energy harvesting transmissions using the second transmit power based on receiving the second configuration.

In some examples, the transmit power manager 1040 may be configured as or otherwise support a means for receiving, from the second UE, an indication of a value for determining the second transmit power for the one or more energy harvesting transmissions. In some examples, the transmit power manager 1040 may be configured as or otherwise support a means for determining the second transmit power for the one or more energy harvesting transmissions using the indicated value.

In some examples, the energy harvesting transmission manager 1035 may be configured as or otherwise support a means for receiving, from the second UE, feedback associated with the one or more energy harvesting transmissions. In some examples, the transmit power manager 1040 may be configured as or otherwise support a means for determining an updated transmit power for subsequent energy harvesting transmissions to the second UE based on the received feedback.

In some examples, the indicated value is based on a quality of service level associated with the one or more energy harvesting transmissions.

In some examples, the transmit power manager 1040 may be configured as or otherwise support a means for identifying an alpha value to use to determine the second transmit power based on a fraction of the second transmit power used at the second UE for energy harvesting. In some examples, the transmit power manager 1040 may be configured as or otherwise support a means for determining the second transmit power for the one or more energy harvesting transmissions using the identified alpha value.

In some examples, to support identifying the alpha value, the transmit power manager 1040 may be configured as or otherwise support a means for receiving, from a base station or from the second UE, the alpha value to use to determine the second transmit power, where the alpha value is based on the fraction of the second transmit power used at the second UE for energy harvesting.

In some examples, to support identifying the alpha value, the transmit power manager 1040 may be configured as or otherwise support a means for identifying the alpha value to use to determine the second transmit power based on a class of the second UE.

In some examples, the pathloss manager 1050 may be configured as or otherwise support a means for receiving, from the second UE, an indication of a pathloss between the first UE and the second UE, where the pathloss is based on a fraction of the second transmit power used at the second UE for energy harvesting. In some examples, the transmit power manager 1040 may be configured as or otherwise support a means for determining the second transmit power for the one or more energy harvesting transmissions using the indicated pathloss.

In some examples, the UE class manager 1055 may be configured as or otherwise support a means for receiving, from the second UE, an indication of a class of the second UE. In some examples, the transmit power manager 1040 may be configured as or otherwise support a means for identifying one or more values for determining the second transmit power for the one or more energy harvesting transmissions to the second UE based on the class of the second UE. In some examples, the transmit power manager 1040 may be configured as or otherwise support a means for determining the second transmit power for the one or more energy harvesting transmissions using a first value of the one or more values.

In some examples, the transmit power manager 1040 may be configured as or otherwise support a means for receiving, from the second UE, feedback on the second transmit power used for the one or more energy harvesting transmissions. In some examples, the transmit power manager 1040 may be configured as or otherwise support a means for determining an updated transmit power for subsequent energy harvesting transmissions to the second UE using a second value of the one or more values based on the received feedback.

In some examples, each of the first configuration and the second configuration includes one or more parameters including one or more of a maximum power, a maximum power based on a channel bit rate, a sidelink transmission power, or an amount of interference at a destination device.

Additionally, or alternatively, the communications manager 1020 may support wireless communication at a second UE in accordance with examples as disclosed herein. The transmit power manager 1040 may be configured as or otherwise support a means for transmitting, to a first UE, an indication of a transmit power for one or more energy harvesting transmissions from the first UE to the second UE. The energy harvester 1045 may be configured as or otherwise support a means for receiving, from the first UE, the one or more energy harvesting transmissions at the indicated transmit power based on transmitting the indication of the transmit power. In some examples, the energy harvester 1045 may be configured as or otherwise support a means for performing, at the second UE, energy harvesting based on receiving the one or more energy harvesting transmissions at the indicated transmit power.

In some examples, to support transmitting the indication of the transmit power, the transmit power manager 1040 may be configured as or otherwise support a means for transmitting, to the first UE, an indication of a value for determining the transmit power for the one or more energy harvesting transmissions, where receiving the one or more energy harvesting transmissions at the indicated transmit power is based on transmitting the indication of the value.

In some examples, the transmit power manager 1040 may be configured as or otherwise support a means for transmitting, to the first UE, feedback associated with the transmit power used for the one or more energy harvesting transmissions. In some examples, the energy harvester 1045 may be configured as or otherwise support a means for receiving subsequent energy harvesting transmissions from the first UE at an updated transmit power based on transmitting the feedback.

In some examples, the indicated value is based on a quality of service level associated with the one or more energy harvesting transmissions.

In some examples, to support transmitting the indication of the transmit power, the transmit power manager 1040 may be configured as or otherwise support a means for transmitting, to the first UE, an indication of an alpha value for the first UE to use to determine the transmit power for the one or more energy harvesting transmissions based on a fraction of the transmit power used at the second UE for energy harvesting, where receiving the one or more energy harvesting transmissions at the indicated transmit power is based on transmitting the indication of the alpha value.

In some examples, the pathloss manager 1050 may be configured as or otherwise support a means for transmitting, to the first UE, an indication of a pathloss between the first UE and the second UE based on a fraction of the transmit power used at the second UE for energy harvesting, where receiving the one or more energy harvesting transmissions at the indicated transmit power is based on transmitting the indication of the pathloss.

In some examples, to support transmitting the indication of the transmit power, the UE class manager 1055 may be configured as or otherwise support a means for transmitting, to the first UE, an indication of a class of the second UE, where receiving the one or more energy harvesting transmissions at the indicated transmit power is based on transmitting the indication of the class of the second UE.

In some examples, the transmit power manager 1040 may be configured as or otherwise support a means for transmitting, to the first UE, feedback on the transmit power used for the one or more energy harvesting transmissions. In some examples, the energy harvester 1045 may be configured as or otherwise support a means for receiving subsequent energy harvesting transmissions from the first UE at an updated transmit power based on transmitting the feedback.

Additionally, or alternatively, the communications manager 1020 may support wireless communication at a first UE in accordance with examples as disclosed herein. In some examples, the transmit power manager 1040 may be configured as or otherwise support a means for receiving, from a second UE, one or more transmissions for assisting the first UE in setting a transmit power for one or more energy harvesting transmissions to the second UE.

In some examples, the transmit power manager 1040 may be configured as or otherwise support a means for determining the transmit power for the one or more energy harvesting transmissions based on the one or more transmissions. In some examples, the energy harvesting transmission manager 1035 may be configured as or otherwise support a means for transmitting, to the second UE, the one or more energy harvesting transmissions using the determined transmit power.

In some examples, to support receiving the one or more transmissions, the SRS manager 1060 may be configured as or otherwise support a means for receiving sounding reference signals from the second UE.

In some examples, the SRS manager 1060 may be configured as or otherwise support a means for performing one or more measurements on the sounding reference signals, where the determining the transmit power is based on performing the one or more measurements.

In some examples, to support receiving the one or more transmissions, the transmit power manager 1040 may be configured as or otherwise support a means for receiving, from the second UE, feedback on a previous transmit power used for a previous energy harvesting transmission, where determining the transmit power for the one or more energy harvesting transmissions is based on the received feedback.

In some examples, to support receiving the one or more transmissions, the transmit power manager 1040 may be configured as or otherwise support a means for receiving, from the second UE, sounding reference signals and feedback on a previous transmit power used for a previous energy harvesting transmission.

In some examples, the SRS manager 1060 may be configured as or otherwise support a means for performing one or more measurements on the sounding reference signals, where determining the transmit power for the one or more energy harvesting transmissions includes. In some examples, the transmit power manager 1040 may be configured as or otherwise support a means for determining the transmit power for the one or more energy harvesting transmissions based on the one or more measurements and the received feedback.

In some examples, the sounding reference signals and the feedback are time division multiplexed or frequency division multiplexed.

Additionally, or alternatively, the communications manager 1020 may support wireless communication at a second UE in accordance with examples as disclosed herein. In some examples, the transmit power manager 1040 may be configured as or otherwise support a means for transmitting, to a first UE, one or more transmissions for assisting the first UE in setting a transmit power for one or more energy harvesting transmissions to the second UE. In some examples, the energy harvester 1045 may be configured as or otherwise support a means for receiving, from the first UE, the one or more energy harvesting transmissions at the transmit power based on transmitting the one or more transmissions. In some examples, the energy harvester 1045 may be configured as or otherwise support a means for performing, at the second UE, energy harvesting based on receiving the one or more energy harvesting transmissions at the transmit power.

In some examples, to support transmitting the one or more transmissions, the SRS manager 1060 may be configured as or otherwise support a means for transmitting sounding reference signals to the first UE, where receiving the one or more energy harvesting transmissions at the transmit power is based on transmitting the sounding reference signals.

In some examples, to support transmitting the one or more transmissions, the transmit power manager 1040 may be configured as or otherwise support a means for transmitting, to the first UE, feedback on a previous transmit power used for a previous energy harvesting transmission, where receiving the one or more energy harvesting transmissions at the transmit power is based on transmitting the feedback.

In some examples, to support transmitting the one or more transmissions, the transmit power manager 1040 may be configured as or otherwise support a means for transmitting, to the first UE, sounding reference signals and feedback on a previous transmit power used for a previous energy harvesting transmission, where receiving the one or more energy harvesting transmissions at the transmit power is based on transmitting the sounding reference signals and the feedback.

In some examples, the sounding reference signals and the feedback are time division multiplexed or frequency division multiplexed.

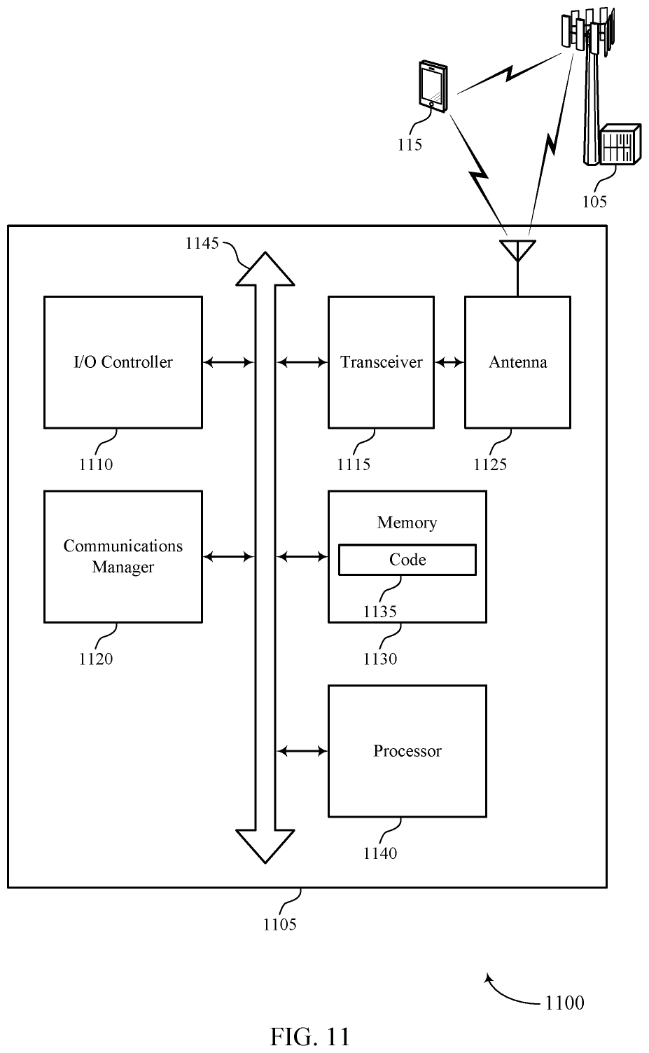

FIG. 11 shows a diagram of a system 1100 including a device 1105 that supports power control for charging UEs and wearables in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting power control for charging UEs and wearables). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a first UE in accordance with examples as disclosed herein. For example, the communications manager 1120 may be configured as or otherwise support a means for receiving a first configuration for setting a first transmit power for one or more data transmissions and a second configuration for setting a second transmit power for one or more energy harvesting transmissions. The communications manager 1120 may be configured as or otherwise support a means for transmitting, to a second UE, the one or more data transmissions using the first transmit power based on receiving the first configuration. The communications manager 1120 may be configured as or otherwise support a means for transmitting, to the second UE, the one or more energy harvesting transmissions using the second transmit power based on receiving the second configuration.

Additionally, or alternatively, the communications manager 1120 may support wireless communication at a second UE in accordance with examples as disclosed herein. For example, the communications manager 1120 may be configured as or otherwise support a means for transmitting, to a first UE, an indication of a transmit power for one or more energy harvesting transmissions from the first UE to the second UE. The communications manager 1120 may be configured as or otherwise support a means for receiving, from the first UE, the one or more energy harvesting transmissions at the indicated transmit power based on transmitting the indication of the transmit power. The communications manager 1120 may be configured as or otherwise support a means for performing, at the second UE, energy harvesting based on receiving the one or more energy harvesting transmissions at the indicated transmit power.

Additionally, or alternatively, the communications manager 1120 may support wireless communication at a first UE in accordance with examples as disclosed herein. For example, the communications manager 1120 may be configured as or otherwise support a means for receiving, from a second UE, one or more transmissions for assisting the first UE in setting a transmit power for one or more energy harvesting transmissions to the second UE. The communications manager 1120 may be configured as or otherwise support a means for determining the transmit power for the one or more energy harvesting transmissions based on the one or more transmissions. The communications manager 1120 may be configured as or otherwise support a means for transmitting, to the second UE, the one or more energy harvesting transmissions using the determined transmit power.

Additionally, or alternatively, the communications manager 1120 may support wireless communication at a second UE in accordance with examples as disclosed herein. For example, the communications manager 1120 may be configured as or otherwise support a means for transmitting, to a first UE, one or more transmissions for assisting the first UE in setting a transmit power for one or more energy harvesting transmissions to the second UE. The communications manager 1120 may be configured as or otherwise support a means for receiving, from the first UE, the one or more energy harvesting transmissions at the transmit power based on transmitting the one or more transmissions. The communications manager 1120 may be configured as or otherwise support a means for performing, at the second UE, energy harvesting based on receiving the one or more energy harvesting transmissions at the transmit power.

By including or configuring the communications manager 1120 in accordance with examples as described herein, the device 1105 may support techniques for improved energy harvesting and more efficient utilization of communication resources. In particular, because a first UE may be configured with different parameters for determining a transmit power for data transmissions and energy harvesting transmissions, the first UE may be able to identify a suitable power for energy harvesting transmissions to improve energy harvesting at a second UE. Further, because a first UE may receive, from a second UE, an indication of a transmit power to use for energy harvesting transmissions to the second UE, the energy harvesting transmissions from the first UE may be more useful resulting in improved energy harvesting at the second UE and more efficient utilization of resources for energy harvesting transmissions.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of power control for charging UEs and wearables as described herein, or the processor 1140 and the memory 1130 may be otherwise configured to perform or support such operations.

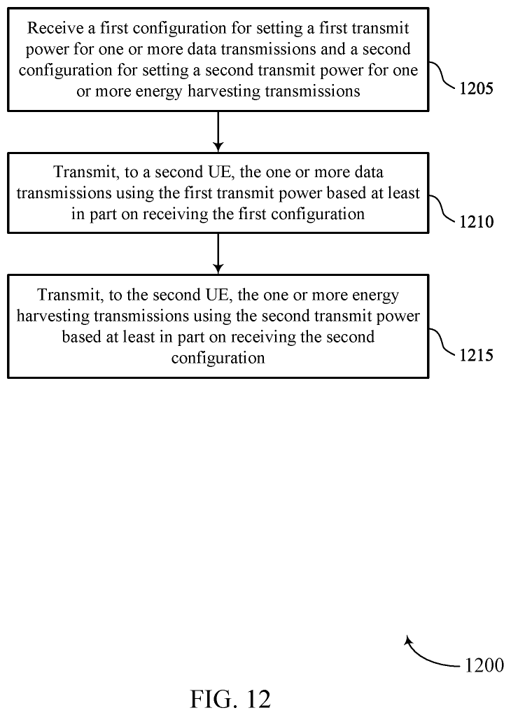

FIG. 12 shows a flowchart illustrating a method 1200 that supports power control for charging UEs and wearables in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a first configuration for setting a first transmit power for one or more data transmissions and a second configuration for setting a second transmit power for one or more energy harvesting transmissions. The operations of 1205 may be performed in accordance with examples as disclosed herein. In some examples, aspects of the operations of 1205 may be performed by a configuration manager 1025 as described with reference to FIG. 10.

At 1210, the method may include transmitting, to a second UE, the one or more data transmissions using the first transmit power based on receiving the first configuration. The operations of 1210 may be performed in accordance with examples as disclosed herein. In some examples, aspects of the operations of 1210 may be performed by a data transmission manager 1030 as described with reference to FIG. 10.

At 1215, the method may include transmitting, to the second UE, the one or more energy harvesting transmissions using the second transmit power based on receiving the second configuration. The operations of 1215 may be performed in accordance with examples as disclosed herein. In some examples, aspects of the operations of 1215 may be performed by an energy harvesting transmission manager 1035 as described with reference to FIG. 10.

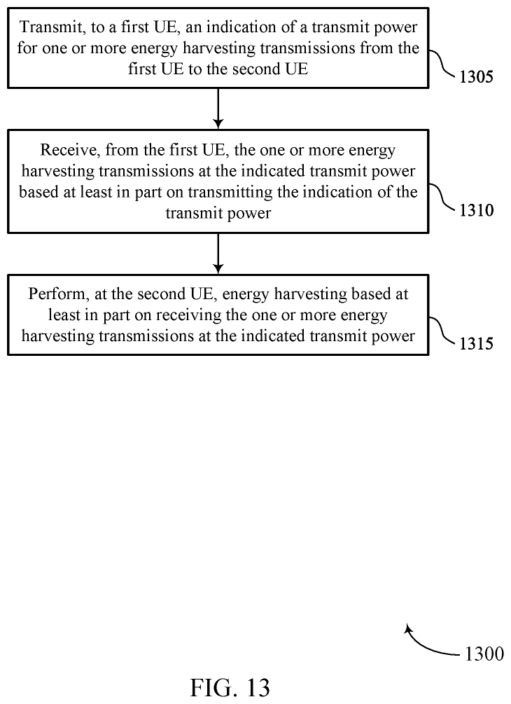

FIG. 13 shows a flowchart illustrating a method 1300 that supports power control for charging UEs and wearables in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include transmitting, to a first UE, an indication of a transmit power for one or more energy harvesting transmissions from the first UE to the second UE. The operations of 1305 may be performed in accordance with examples as disclosed herein. In some examples, aspects of the operations of 1305 may be performed by a transmit power manager 1040 as described with reference to FIG. 10.

At 1310, the method may include receiving, from the first UE, the one or more energy harvesting transmissions at the indicated transmit power based on transmitting the indication of the transmit power. The operations of 1310 may be performed in accordance with examples as disclosed herein. In some examples, aspects of the operations of 1310 may be performed by an energy harvester 1045 as described with reference to FIG. 10.

At 1315, the method may include performing, at the second UE, energy harvesting based on receiving the one or more energy harvesting transmissions at the indicated transmit power. The operations of 1315 may be performed in accordance with examples as disclosed herein. In some examples, aspects of the operations of 1315 may be performed by an energy harvester 1045 as described with reference to FIG. 10.

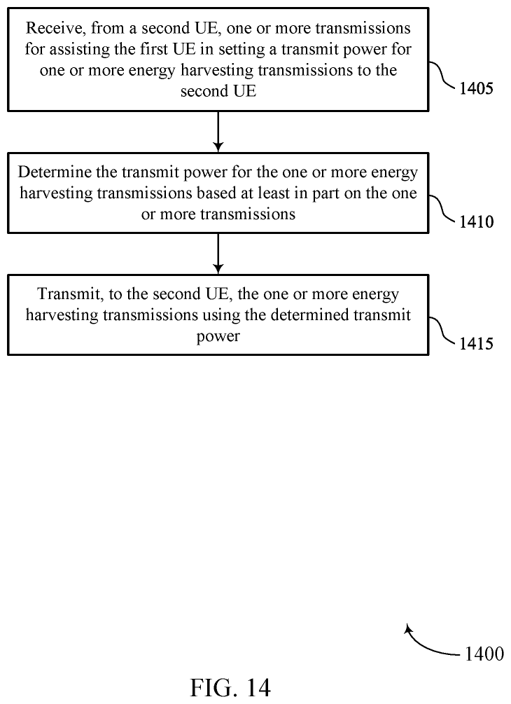

FIG. 14 shows a flowchart illustrating a method 1400 that supports power control for charging UEs and wearables in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving, from a second UE, one or more transmissions for assisting the first UE in setting a transmit power for one or more energy harvesting transmissions to the second UE. The operations of 1405 may be performed in accordance with examples as disclosed herein. In some examples, aspects of the operations of 1405 may be performed by a transmit power manager 1040 as described with reference to FIG. 10.

At 1410, the method may include determining the transmit power for the one or more energy harvesting transmissions based on the one or more transmissions. The operations of 1410 may be performed in accordance with examples as disclosed herein. In some examples, aspects of the operations of 1410 may be performed by a transmit power manager 1040 as described with reference to FIG. 10.

At 1415, the method may include transmitting, to the second UE, the one or more energy harvesting transmissions using the determined transmit power. The operations of 1415 may be performed in accordance with examples as disclosed herein. In some examples, aspects of the operations of 1415 may be performed by an energy harvesting transmission manager 1035 as described with reference to FIG. 10.

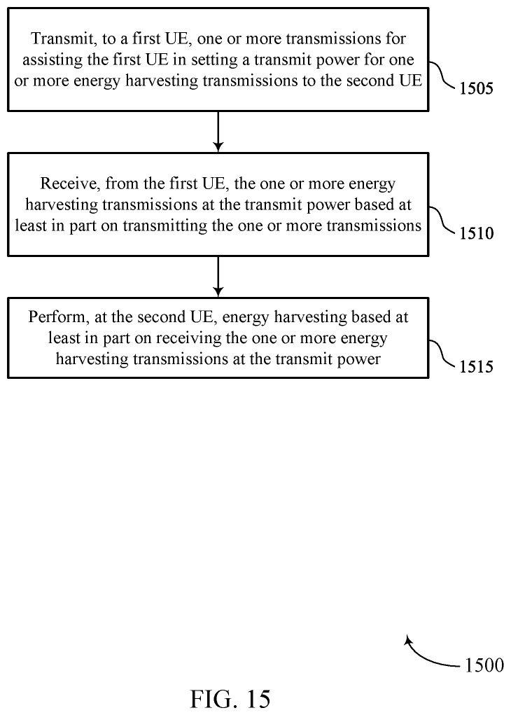

FIG. 15 shows a flowchart illustrating a method 1500 that supports power control for charging UEs and wearables in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include transmitting, to a first UE, one or more transmissions for assisting the first UE in setting a transmit power for one or more energy harvesting transmissions to the second UE. The operations of 1505 may be performed in accordance with examples as disclosed herein. In some examples, aspects of the operations of 1505 may be performed by a transmit power manager 1040 as described with reference to FIG. 10.

At 1510, the method may include receiving, from the first UE, the one or more energy harvesting transmissions at the transmit power based on transmitting the one or more transmissions. The operations of 1510 may be performed in accordance with examples as disclosed herein. In some examples, aspects of the operations of 1510 may be performed by an energy harvester 1045 as described with reference to FIG. 10.

At 1515, the method may include performing, at the second UE, energy harvesting based on receiving the one or more energy harvesting transmissions at the transmit power. The operations of 1515 may be performed in accordance with examples as disclosed herein.

In some examples, aspects of the operations of 1515 may be performed by an energy harvester 1045 as described with reference to FIG. 10.

The following provides an overview of aspects of the present disclosure:

Aspect 1: A method for wireless communication at a first UE, comprising: receiving a first configuration for setting a first transmit power for one or more data transmissions and a second configuration for setting a second transmit power for one or more energy harvesting transmissions: transmitting, to a second UE, the one or more data transmissions using the first transmit power based at least in part on receiving the first configuration; and transmitting, to the second UE, the one or more energy harvesting transmissions using the second transmit power based at least in part on receiving the second configuration.

Aspect 2: The method of aspect 1, further comprising: receiving, from the second UE, an indication of a value for determining the second transmit power for the one or more energy harvesting transmissions; and determining the second transmit power for the one or more energy harvesting transmissions using the indicated value.

Aspect 3: The method of aspect 2, further comprising: receiving, from the second UE, feedback associated with the one or more energy harvesting transmissions; and determining an updated transmit power for subsequent energy harvesting transmissions to the second UE based at least in part on the received feedback.

Aspect 4: The method of any of aspects 2 through 3, wherein the indicated value is based at least in part on a quality of service level associated with the one or more energy harvesting transmissions.

Aspect 5: The method of any of aspects 1 through 4, further comprising: identifying an alpha value to use to determine the second transmit power based at least in part on a fraction of the second transmit power used at the second UE for energy harvesting; and determining the second transmit power for the one or more energy harvesting transmissions using the identified alpha value.

Aspect 6: The method of aspect 5, wherein identifying the alpha value comprises: receiving, from a base station or from the second UE, the alpha value to use to determine the second transmit power, wherein the alpha value is based at least in part on the fraction of the second transmit power used at the second UE for energy harvesting.

Aspect 7: The method of any of aspects 5 through 6, wherein identifying the alpha value comprises: identifying the alpha value to use to determine the second transmit power based at least in part on a class of the second UE.

Aspect 8: The method of any of aspects 1 through 7, further comprising: receiving, from the second UE, an indication of a pathloss between the first UE and the second UE, wherein the pathloss is based at least in part on a fraction of the second transmit power used at the second UE for energy harvesting; and determining the second transmit power for the one or more energy harvesting transmissions using the indicated pathloss.

Aspect 9: The method of any of aspects 1 through 8, further comprising: receiving, from the second UE, an indication of a class of the second UE: identifying one or more values for determining the second transmit power for the one or more energy harvesting transmissions to the second UE based at least in part on the class of the second UE; and determining the second transmit power for the one or more energy harvesting transmissions using a first value of the one or more values.

Aspect 10: The method of aspect 9, further comprising: receiving, from the second UE, feedback on the second transmit power used for the one or more energy harvesting transmissions; and determining an updated transmit power for subsequent energy harvesting transmissions to the second UE using a second value of the one or more values based at least in part on the received feedback.

Aspect 11: The method of any of aspects 1 through 10, wherein each of the first configuration and the second configuration comprises one or more parameters including one or more of a maximum power, a maximum power based at least in part on a channel busy ratio, a sidelink transmission power, or an amount of interference at a destination device.

Aspect 12: A method for wireless communication at a second UE, comprising: transmitting, to a first UE, an indication of a transmit power for one or more energy harvesting transmissions from the first UE to the second UE; receiving, from the first UE, the one or more energy harvesting transmissions at the indicated transmit power based at least in part on transmitting the indication of the transmit power; and performing, at the second UE, energy harvesting based at least in part on receiving the one or more energy harvesting transmissions at the indicated transmit power.

Aspect 13: The method of aspect 12, wherein transmitting the indication of the transmit power comprises: transmitting, to the first UE, an indication of a value for determining the transmit power for the one or more energy harvesting transmissions, wherein receiving the one or more energy harvesting transmissions at the indicated transmit power is based at least in part on transmitting the indication of the value.

Aspect 14: The method of aspect 13, further comprising: transmitting, to the first UE, feedback associated with the transmit power used for the one or more energy harvesting transmissions; and receiving subsequent energy harvesting transmissions from the first UE at an updated transmit power based at least in part on transmitting the feedback.

Aspect 15: The method of any of aspects 13 through 14, wherein the indicated value is based at least in part on a quality of service level associated with the one or more energy harvesting transmissions.

Aspect 16: The method of any of aspects 12 through 15, wherein transmitting the indication of the transmit power comprises: transmitting, to the first UE, an indication of an alpha value for the first UE to use to determine the transmit power for the one or more energy harvesting transmissions based at least in part on a fraction of the transmit power used at the second UE for energy harvesting, wherein receiving the one or more energy harvesting transmissions at the indicated transmit power is based at least in part on transmitting the indication of the alpha value.

Aspect 17: The method of any of aspects 12 through 16, further comprising: transmitting, to the first UE, an indication of a pathloss between the first UE and the second UE based at least in part on a fraction of the transmit power used at the second UE for energy harvesting, wherein receiving the one or more energy harvesting transmissions at the indicated transmit power is based at least in part on transmitting the indication of the pathloss.

Aspect 18: The method of any of aspects 12 through 17, wherein transmitting the indication of the transmit power comprises: transmitting, to the first UE, an indication of a class of the second UE, wherein receiving the one or more energy harvesting transmissions at the indicated transmit power is based at least in part on transmitting the indication of the class of the second UE.

Aspect 19: The method of aspect 18, further comprising: transmitting, to the first UE, feedback on the transmit power used for the one or more energy harvesting transmissions; and receiving subsequent energy harvesting transmissions from the first UE at an updated transmit power based at least in part on transmitting the feedback.

Aspect 20: A method for wireless communication at a first UE, comprising: receiving, from a second UE, one or more transmissions for assisting the first UE in setting a transmit power for one or more energy harvesting transmissions to the second UE; determining the transmit power for the one or more energy harvesting transmissions based at least in part on the one or more transmissions; and transmitting, to the second UE, the one or more energy harvesting transmissions using the determined transmit power.

Aspect 21: The method of aspect 20, wherein receiving the one or more transmissions comprises: receiving sounding reference signals from the second UE.

Aspect 22: The method of aspect 21, further comprising: performing one or more measurements on the sounding reference signals, wherein the determining the transmit power is based at least in part on performing the one or more measurements.

Aspect 23: The method of any of aspects 20 through 22, wherein receiving the one or more transmissions comprises: receiving, from the second UE, feedback on a previous transmit power used for a previous energy harvesting transmission, wherein determining the transmit power for the one or more energy harvesting transmissions is based at least in part on the received feedback.

Aspect 24: The method of any of aspects 20 through 23, wherein receiving the one or more transmissions comprises: receiving, from the second UE, sounding reference signals and feedback on a previous transmit power used for a previous energy harvesting transmission.

Aspect 25: The method of aspect 24, further comprising: performing one or more measurements on the sounding reference signals, wherein determining the transmit power for the one or more energy harvesting transmissions comprises: determining the transmit power for the one or more energy harvesting transmissions based at least in part on the one or more measurements and the received feedback.

Aspect 26: The method of any of aspects 24 through 25, wherein the sounding reference signals and the feedback are time division multiplexed or frequency division multiplexed.

Aspect 27: A method for wireless communication at a second UE, comprising: transmitting, to a first UE, one or more transmissions for assisting the first UE in setting a transmit power for one or more energy harvesting transmissions to the second UE; receiving, from the first UE, the one or more energy harvesting transmissions at the transmit power based at least in part on transmitting the one or more transmissions; and performing, at the second UE, energy harvesting based at least in part on receiving the one or more energy harvesting transmissions at the transmit power.

Aspect 28: The method of aspect 27, wherein transmitting the one or more transmissions comprises: transmitting sounding reference signals to the first UE, wherein receiving the one or more energy harvesting transmissions at the transmit power is based at least in part on transmitting the sounding reference signals.

Aspect 29: The method of any of aspects 27 through 28, wherein transmitting the one or more transmissions comprises: transmitting, to the first UE, feedback on a previous transmit power used for a previous energy harvesting transmission, wherein receiving the one or more energy harvesting transmissions at the transmit power is based at least in part on transmitting the feedback.

Aspect 30: The method of any of aspects 27 through 29, wherein transmitting the one or more transmissions comprises: transmitting, to the first UE, sounding reference signals and feedback on a previous transmit power used for a previous energy harvesting transmission, wherein receiving the one or more energy harvesting transmissions at the transmit power is based at least in part on transmitting the sounding reference signals and the feedback.

Aspect 31: The method of aspect 30, wherein the sounding reference signals and the feedback are time division multiplexed or frequency division multiplexed.

Aspect 32: An apparatus for wireless communication at a first UE, comprising a processor: memory coupled with the processor; and instructions stored in the memory and executable by the processor to cause the apparatus to perform a method of any of aspects 1 through 11.

Aspect 33: An apparatus for wireless communication at a first UE, comprising at least one means for performing a method of any of aspects 1 through 11.

Aspect 34: A non-transitory computer-readable medium storing code for wireless communication at a first UE, the code comprising instructions executable by a processor to perform a method of any of aspects 1 through 11.

Aspect 35: An apparatus for wireless communication at a second UE, comprising a processor: memory coupled with the processor; and instructions stored in the memory and executable by the processor to cause the apparatus to perform a method of any of aspects 12 through 19.

Aspect 36: An apparatus for wireless communication at a second UE, comprising at least one means for performing a method of any of aspects 12 through 19.

Aspect 37: A non-transitory computer-readable medium storing code for wireless communication at a second UE, the code comprising instructions executable by a processor to perform a method of any of aspects 12 through 19.

Aspect 38: An apparatus for wireless communication at a first UE, comprising a processor: memory coupled with the processor; and instructions stored in the memory and executable by the processor to cause the apparatus to perform a method of any of aspects 20 through 26.

Aspect 39: An apparatus for wireless communication at a first UE, comprising at least one means for performing a method of any of aspects 20 through 26.

Aspect 40: A non-transitory computer-readable medium storing code for wireless communication at a first UE, the code comprising instructions executable by a processor to perform a method of any of aspects 20 through 26.

Aspect 41: An apparatus for wireless communication at a second UE, comprising a processor: memory coupled with the processor; and instructions stored in the memory and executable by the processor to cause the apparatus to perform a method of any of aspects 27 through 31.

Aspect 42: An apparatus for wireless communication at a second UE, comprising at least one means for performing a method of any of aspects 27 through 31.

Aspect 43: A non-transitory computer-readable medium storing code for wireless communication at a second UE, the code comprising instructions executable by a processor to perform a method of any of aspects 27 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive a first configuration for setting a first transmit power for one or more data transmissions and a second configuration for setting a second transmit power for one or more energy harvesting transmissions;
transmit, to a second UE, the one or more data transmissions using the first transmit power based at least in part on receiving the first configuration; and
transmit, to the second UE, the one or more energy harvesting transmissions using the second transmit power based at least in part on receiving the second configuration.

2. The apparatus of claim 1, wherein the instructions are further executable by the processor to cause the apparatus to:
receive, from the second UE, an indication of a value for determining the second transmit power for the one or more energy harvesting transmissions; and
determine the second transmit power for the one or more energy harvesting transmissions using the indicated value.

3. The apparatus of claim 2, wherein the instructions are further executable by the processor to cause the apparatus to:
receive, from the second UE, feedback associated with the one or more energy harvesting transmissions; and
determine an updated transmit power for subsequent energy harvesting transmissions to the second UE based at least in part on the received feedback.

4. The apparatus of claim 2, wherein the indicated value is based at least in part on a quality of service level associated with the one or more energy harvesting transmissions.

5. The apparatus of claim 1, wherein the instructions are further executable by the processor to cause the apparatus to:
identify an alpha value to use to determine the second transmit power based at least in part on a fraction of the second transmit power used at the second UE for energy harvesting; and
determine the second transmit power for the one or more energy harvesting transmissions using the identified alpha value.

6. The apparatus of claim 5, wherein the instructions to identify the alpha value are executable by the processor to cause the apparatus to:
receive, from a base station or from the second UE, the alpha value to use to determine the second transmit power, wherein the alpha value is based at least in part on the fraction of the second transmit power used at the second UE for energy harvesting.

7. The apparatus of claim 5, wherein the instructions to identify the alpha value are executable by the processor to cause the apparatus to:
identify the alpha value to use to determine the second transmit power based at least in part on a class of the second UE.

8. The apparatus of claim 1, wherein the instructions are further executable by the processor to cause the apparatus to:
receive, from the second UE, an indication of a pathloss between the first UE and the second UE, wherein the pathloss is based at least in part on a fraction of the second transmit power used at the second UE for energy harvesting; and
determine the second transmit power for the one or more energy harvesting transmissions using the indicated pathloss.

9. The apparatus of claim 1, wherein the instructions are further executable by the processor to cause the apparatus to:
receive, from the second UE, an indication of a class of the second UE;
identify one or more values for determining the second transmit power for the one or more energy harvesting transmissions to the second UE based at least in part on the class of the second UE; and
determine the second transmit power for the one or more energy harvesting transmissions using a first value of the one or more values.

10. The apparatus of claim 9, wherein the instructions are further executable by the processor to cause the apparatus to:
receive, from the second UE, feedback on the second transmit power used for the one or more energy harvesting transmissions; and
determine an updated transmit power for subsequent energy harvesting transmissions to the second UE using a second value in the set of values based at least in part on the received feedback.

11. The apparatus of claim 1, wherein each of the first configuration and the second configuration comprises one or more parameters including one or more of a maximum power, a maximum power based at least in part on a channel busy ratio, a sidelink transmission power, or an amount of interference at a destination device.

12. An apparatus for wireless communication at a second UE, comprising:
a processor;
memory coupled with the processor; and
instructions stored in the memory and executable by the processor to cause the apparatus to:
transmit, to a first UE, an indication of a transmit power for one or more energy harvesting transmissions from the first UE to the second UE;
receive, from the first UE, the one or more energy harvesting transmissions at the indicated transmit power based at least in part on transmitting the indication of the transmit power; and
perform, at the second UE, energy harvesting based at least in part on receiving the one or more energy harvesting transmissions at the indicated transmit power.

13. The apparatus of claim 12, wherein the instructions to transmit the indication of the transmit power are executable by the processor to cause the apparatus to:
transmit, to the first UE, an indication of a value for determining the transmit power for the one or more energy harvesting transmissions, wherein receiving the one or more energy harvesting transmissions at the indicated transmit power is based at least in part on transmitting the indication of the value.

14. The apparatus of claim 13, wherein the instructions are further executable by the processor to cause the apparatus to:
transmit, to the first UE, feedback associated with the transmit power used for the one or more energy harvesting transmissions; and
receive subsequent energy harvesting transmissions from the first UE at an updated transmit power based at least in part on transmitting the feedback.

15. The apparatus of claim 13, wherein the indicated value is based at least in part on a quality of service level associated with the one or more energy harvesting transmissions.

16. The apparatus of claim 12, wherein the instructions to transmit the indication of the transmit power are executable by the processor to cause the apparatus to:
transmit, to the first UE, an indication of an alpha value for the first UE to use to determine the transmit power for the one or more energy harvesting transmissions based at least in part on a fraction of the transmit power used at the second UE for energy harvesting, wherein receiving the one or more energy harvesting transmissions at the indicated transmit power is based at least in part on transmitting the indication of the alpha value.

17. The apparatus of claim 12, wherein the instructions are further executable by the processor to cause the apparatus to:
transmit, to the first UE, an indication of a pathloss between the first UE and the second UE based at least in part on a fraction of the transmit power used at the second UE for energy harvesting, wherein receiving the one or more energy harvesting transmissions at the indicated transmit power is based at least in part on transmitting the indication of the pathloss.

18. The apparatus of claim 12, wherein the instructions to transmit the indication of the transmit power are executable by the processor to cause the apparatus to:
transmit, to the first UE, an indication of a class of the second UE, wherein receiving the one or more energy harvesting transmissions at the indicated transmit power is based at least in part on transmitting the indication of the class of the second UE.

19. The apparatus of claim 18, wherein the instructions are further executable by the processor to cause the apparatus to:
transmit, to the first UE, feedback on the transmit power used for the one or more energy harvesting transmissions; and
receive subsequent energy harvesting transmissions from the first UE at an updated transmit power based at least in part on transmitting the feedback.

20. An apparatus for wireless communication at a first user equipment (UE), comprising:
a processor;
memory coupled with the processor; and
instructions stored in the memory and executable by the processor to cause the apparatus to:
receive, from a second UE, one or more transmissions for assisting the first UE in setting a transmit power for one or more energy harvesting transmissions to the second UE:
determine the transmit power for the one or more energy harvesting transmissions based at least in part on the one or more transmissions; and
transmit, to the second UE, the one or more energy harvesting transmissions using the determined transmit power.

21. The apparatus of claim 20, wherein the instructions to receive the one or more transmissions are executable by the processor to cause the apparatus to:
receive sounding reference signals from the second UE.

22. The apparatus of claim 21, wherein the instructions are further executable by the processor to cause the apparatus to:
perform one or more measurements on the sounding reference signals, wherein the determining the transmit power is based at least in part on performing the one or more measurements.

23. The apparatus of claim 20, wherein the instructions to receive the one or more transmissions are executable by the processor to cause the apparatus to:
receive, from the second UE, feedback on a previous transmit power used for a previous energy harvesting transmission, wherein determining the transmit power for the one or more energy harvesting transmissions is based at least in part on the received feedback.

24. The apparatus of claim 20, wherein the instructions to receive the one or more transmissions are executable by the processor to cause the apparatus to:
receive, from the second UE, sounding reference signals and feedback on a previous transmit power used for a previous energy harvesting transmission.

25. The apparatus of claim 24, wherein the instructions are further executable by the processor to cause the apparatus to:
perform one or more measurements on the sounding reference signals, wherein determining the transmit power for the one or more energy harvesting transmissions comprises:
determine the transmit power for the one or more energy harvesting transmissions based at least in part on the one or more measurements and the received feedback.

26. The apparatus of claim 24, wherein the sounding reference signals and the feedback are time division multiplexed or frequency division multiplexed.

27. An apparatus for wireless communication at a second user equipment (UE), comprising:
a processor;
memory coupled with the processor; and
instructions stored in the memory and executable by the processor to cause the apparatus to:
transmit, to a first UE, one or more transmissions for assisting the first UE in setting a transmit power for one or more energy harvesting transmissions to the second UE;
receive, from the first UE, the one or more energy harvesting transmissions at the transmit power based at least in part on transmitting the one or more transmissions; and
perform, at the second UE, energy harvesting based at least in part on receiving the one or more energy harvesting transmissions at the transmit power.

28. The apparatus of claim 27, wherein the instructions to transmit the one or more transmissions are executable by the processor to cause the apparatus to:
transmit sounding reference signals to the first UE, wherein receiving the one or more energy harvesting transmissions at the transmit power is based at least in part on transmitting the sounding reference signals.

29. The apparatus of claim 27, wherein the instructions to transmit the one or more transmissions are executable by the processor to cause the apparatus to:
transmit, to the first UE, feedback on a previous transmit power used for a previous energy harvesting transmission, wherein receiving the one or more energy harvesting transmissions at the transmit power is based at least in part on transmitting the feedback.

30. The apparatus of claim 27, wherein the instructions to transmit the one or more transmissions are executable by the processor to cause the apparatus to:
transmit, to the first UE, sounding reference signals and feedback on a previous transmit power used for a previous energy harvesting transmission, wherein receiving the one or more energy harvesting transmissions at the transmit power is based at least in part on transmitting the sounding reference signals and the feedback.
